(19) United States
(12) Patent Application Publication
(10) Pub. No.: US 2016/0364794 A1
(43) Pub. Date: Dec. 15, 2016

(54) SCORING TRANSACTIONAL FRAUD USING FEATURES OF TRANSACTION PAYMENT RELATIONSHIP GRAPHS

(71) Applicants: International Business Machines Corporation, Armonk, NY (US); ABN AMRO Bank, N.V., Amsterdam (NL)

(72) Inventors: Suresh N. Chari, Tarrytown, NY (US); Ted A. Habeck, Fishkill, NY (US); Coenraad Jan Jonker, Amsterdam (NL); Frank Jördens, Amsterdam (NL); Ian M. Molloy, Chappaqua, NY (US); Youngja Park, Princeton, NJ (US); Cornelis van Schaik, Wijk bij Duurstede (NL); Mark Edwin Wiggerman, Haarlem (NL)

(21) Appl. No.: 14/862,656

(22) Filed: Sep. 23, 2015

Related U.S. Application Data
(60) Provisional application No. 62/173,007, filed on Jun. 9, 2015.

(51) Int. Cl. G06Q 40/02

(52) U.S. Cl. CPC G06Q 40/02

(57) ABSTRACT

Identifying fraudulent transactions is provided. Transactions data corresponding to a plurality of transactions between accounts are obtained from one or more different transaction channels. At least one graph of transaction payment relationships between the accounts is generated from the transaction data. Features are extracted from the at least one graph of transaction payment relationships between the accounts. A fraud score for a current transaction is generated based on the extracted features from the at least one graph of transaction payment relationships between the accounts.

### BACKGROUND

1. Field

The disclosure relates generally to automatically identifying fraudulent transactions and more specifically to utilizing transaction data from one or more channels of transaction to score transactions and utilize the transaction scores to identify and block fraudulent transactions and/or forward such transactions to a fraud risk management system.

2. Description of the Related Art

Traditionally, scoring of transactions to detect payment fraud has focused on statistical properties of the payer in the transaction (e.g., too many transactions in a day), parameters of the transaction (e.g., an account used to perform multiple automated-teller machine withdrawals within a 5 minute period at multiple locations that are geographically distant from each other), or features associated with the transaction channel used to perform the transaction (e.g., Internet Protocol (IP) address of device used to perform an online transaction or indications of malware being present on the device used in the online transaction). Further, these statistical and other models are typically applicable to a single transaction channel with a different fraud model for each channel.

### SUMMARY

According to one illustrative embodiment, a computer-implemented method for identifying fraudulent transactions is provided. A data processing system obtains transactions data corresponding to a plurality of transactions between accounts from one or more different transaction channels. The data processing system generates at least one graph of transaction payment relationships between the accounts from the transaction data. The data processing system extracts features from the at least one graph of transaction payment relationships between the accounts. The data processing system generates a fraud score for a current transaction based on the extracted features from the at least one graph of transaction payment relationships between the accounts. According to other illustrative embodiments, a data processing system and computer program product for identifying fraudulent transactions are provided.

### BRIEF DESCRIPTION OF THE DRAWINGS

FIG. 1 is a pictorial representation of a network of data processing systems in which illustrative embodiments may be implemented;

FIG. 2 is a diagram of a data processing system in which illustrative embodiments may be implemented;

FIG. 3 is a diagram of an example transaction payment relationship graph showing vertices corresponding to example transactions between accounts in accordance with an illustrative embodiment;

FIG. 4 is a diagram of an example graph-based fraudulent transaction scoring process in accordance with an illustrative embodiment;

FIGS. 5A-5B are a flowchart illustrating a process for fraudulent transaction scoring in accordance with an illustrative embodiment;

FIG. 6 is a diagram of an example of time window transaction payment relationship graph generation process in accordance with an illustrative embodiment;

FIG. 7 is a diagram of an example of a time window transaction payment relationship graph aging process to score current transactions in accordance with an illustrative embodiment;

FIG. 8 is a flowchart illustrating a process for aggregating fraudulent transaction scores corresponding to a set of one or more relevant transaction payment relationship graphs based on features extracted from the set of relevant transaction payment relationship graphs in accordance with an illustrative embodiment;

FIG. 9 is a flowchart illustrating a process for generating a fraudulent transaction score using a shortest distance and a shortest edge path between a source account vertex and a destination account vertex corresponding to a transaction within a set of one or more relevant transaction payment relationship graphs in accordance with an illustrative embodiment;

FIG. 10 is a flowchart illustrating a process for generating a fraudulent transaction score using a PageRank of a source account vertex and a destination account vertex corresponding to a transaction within a set of one or more relevant transaction payment relationship graphs in accordance with an illustrative embodiment;

FIG. 11 is a flowchart illustrating a process for generating a fraudulent transaction score using monetary flow between a source account vertex and a destination account vertex corresponding to a transaction within a set of one or more relevant transaction payment relationship graphs in accordance with an illustrative embodiment;

FIG. 12 is a flowchart illustrating a process for generating a fraudulent transaction score using connected components of a source account vertex and a destination account vertex corresponding to a transaction within a set of one or more relevant transaction payment relationship graphs in accordance with an illustrative embodiment;

FIG. 13 is a flowchart illustrating a process for generating a fraudulent transaction score using a level of connectivity between a source account vertex and a destination account vertex corresponding to a transaction within a set of one or more relevant transaction payment relationship graphs in accordance with an illustrative embodiment;

FIG. 14 is a flowchart illustrating a process for generating a fraudulent transaction score using clustering of vertices within a set of one or more relevant transaction payment relationship graphs in accordance with an illustrative embodiment; and

FIG. 15 is a diagram of an example of an ego account vertex sub-graph in accordance with an illustrative embodiment.

### DETAILED DESCRIPTION

The present invention may be a system, a method, and/or a computer program product. The computer program product may include a computer readable storage medium (or media) having computer readable program instructions thereon for causing a processor to carry out aspects of the present invention.

The computer readable storage medium can be a tangible device that can retain and store instructions for use by an instruction execution device. The computer readable storage medium may be, for example, but is not limited to, an electronic storage device, a magnetic storage device, an optical storage device, an electromagnetic storage device, a semiconductor storage device, or any suitable combination of the foregoing. A non-exhaustive list of more specific examples of the computer readable storage medium includes the following: a portable computer diskette, a hard disk, a random access memory (RAM), a read-only memory (ROM), an erasable programmable read-only memory (EPROM or Flash memory), a static random access memory (SRAM), a portable compact disc read-only memory (CD-ROM), a digital versatile disk (DVD), a memory stick, a floppy disk, a mechanically encoded device such as punch-cards or raised structures in a groove having instructions recorded thereon, and any suitable combination of the foregoing. A computer readable storage medium, as used herein, is not to be construed as being transitory signals per se, such as radio waves or other freely propagating electromagnetic waves, electromagnetic waves propagating through a waveguide or other transmission media (e.g., light pulses passing through a fiber-optic cable), or electrical signals transmitted through a wire.

Computer readable program instructions described herein can be downloaded to respective computing/processing devices from a computer readable storage medium or to an external computer or external storage device via a network, for example, the Internet, a local area network, a wide area network and/or a wireless network. The network may comprise copper transmission cables, optical transmission fibers, wireless transmission, routers, firewalls, switches, gateway computers and/or edge servers. A network adapter card or network interface in each computing/processing device receives computer readable program instructions from the network and forwards the computer readable program instructions for storage in a computer readable storage medium within the respective computing/processing device.

Computer readable program instructions for carrying out operations of the present invention may be assembler instructions, instruction-set-architecture (ISA) instructions, machine instructions, machine dependent instructions, microcode, firmware instructions, state-setting data, or either source code or object code written in any combination of one or more programming languages, including an object oriented programming language such as Smalltalk, C++ or the like, and conventional procedural programming languages, such as the “C” programming language or similar programming languages. The computer readable program instructions may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider). In some embodiments, electronic circuitry including, for example, programmable logic circuitry, field-programmable gate arrays (FPGA), or programmable logic arrays (PLA) may execute the computer readable program instructions by utilizing state information of the computer readable program instructions to personalize the electronic circuitry, in order to perform aspects of the present invention.

Aspects of the present invention are described below with reference to flowchart illustrations and/or block diagrams of methods, apparatus (systems) and computer program products according to embodiments of the invention. It will be understood that each block of the flowchart illustrations and/or block diagrams, and combinations of blocks in the flowchart illustrations and/or block diagrams, can be implemented by computer readable program instructions.

These computer program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks. These computer program instructions may also be stored in a computer readable medium that can direct a computer, other programmable data processing apparatus, or other devices to function in a particular manner, such that the instructions stored in the computer readable medium produce an article of manufacture including instructions which implement the function/act specified in the flowchart and/or block diagram block or blocks.

The computer readable program instructions may also be loaded onto a computer, other programmable data processing apparatus, or other device to cause a series of operational steps to be performed on the computer, other programmable apparatus or other device to produce a computer implemented process, such that the instructions which execute on the computer, other programmable apparatus, or other device implement the functions/acts specified in the flowchart and/or block diagram block or blocks.

The flowchart and block diagrams in the Figures illustrate the architecture, functionality, and operation of possible implementations of systems, methods, and computer program products according to various embodiments of the present invention. In this regard, each block in the flowchart or block diagrams may represent a module, segment, or portion of instructions, which comprises one or more executable instructions for implementing the specified logical function(s). In some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts or carry out combinations of special purpose hardware and computer instructions.

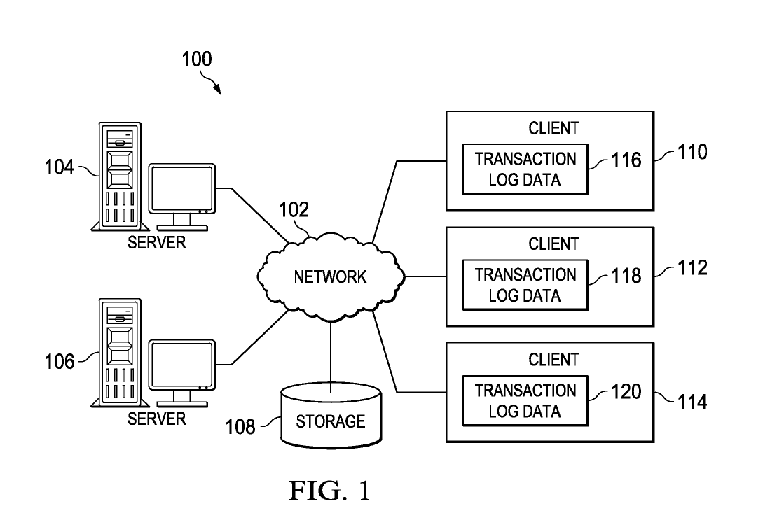

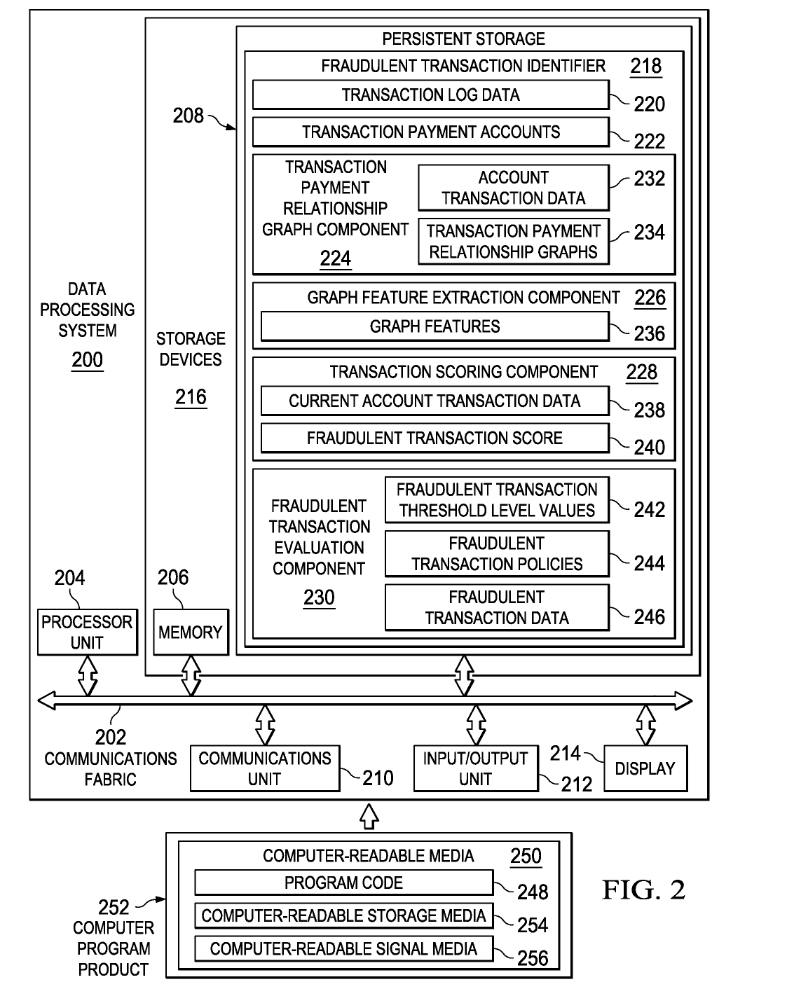

With reference now to the figures, and in particular, with reference to FIGS. 1-2, diagrams of data processing environments are provided in which illustrative embodiments may be implemented. It should be appreciated that FIGS. 1-2 are only meant as examples and are not intended to assert or imply any limitation with regard to the environments in which different embodiments may be implemented. Many modifications to the depicted environments may be made.

FIG. 1 depicts a pictorial representation of a network of data processing systems in which illustrative embodiments may be implemented. Network data processing system 100 is a network of computers and other devices in which the illustrative embodiments may be implemented. Network data processing system 100 contains network 102, which is the medium used to provide communications links between the computers and the other devices connected together within network data processing system 100. Network 102 may include connections, such as, for example, wire communication links, wireless communication links, and fiber optic cables.

In the depicted example, server 104 and server 106 connect to network 102, along with storage 108. Server 104 and server 106 may be, for example, server computers with high-speed connections to network 102. In addition, server 104 and server 106 may provide services, such as, for example, services that automatically identify and block fraudulent financial transactions being performed on registered client devices.

Client device 110, client device 112, and client device 114 also connect to network 102. Client devices 110, 112, and 114 are registered clients of server 104 and server 106. Server 104 and server 106 may provide information, such as boot files, operating system images, and software applications to client devices 110, 112, and 114.

Client devices 110, 112, and 114 may be, for example, computers, such as network computers or desktop computers with wire or wireless communication links to network 102. However, it should be noted that client devices 110, 112, and 114 are intended as examples only. In other words, client devices 110, 112, and 114 also may include other devices, such as, for example, automated teller machines, point-of-sale terminals, kiosks, laptop computers, handheld computers, smart phones, personal digital assistants, or any combination thereof. Users of client devices 110, 112, and 114 may use client devices 110, 112, and 114 to perform financial transactions, such as, for example, transferring monetary funds from a source or paying financial account to a destination or receiving financial account to complete a financial transaction.

In this example, client device 110, client device 112, and client device 114 include transaction log data 116, transaction log data 118, and transaction log data 120, respectively. Transaction log data 116, transaction log data 118, and transaction log data 120 are information regarding financial transactions performed on client device 110, client device 112, and client device 114, respectively. The transaction log data may include, for example, financial transactions performed on a point-of-sale terminal, financial transactions performed on an automated teller machine, credit card account transaction logs, bank account transaction logs, online purchase transaction logs, mobile phone transaction payment logs, and the like.

Storage 108 is a network storage device capable of storing any type of data in a structured format or an unstructured format. In addition, storage 108 may represent a set of one or more network storage devices. Storage 108 may store, for example, historic transaction log data, real-time transaction log data, lists of financial accounts used in financial transactions, names and identification numbers of financial account owners, financial transaction payment relationship graphs, scores for financial transactions, and fraudulent financial transaction threshold level values. Further, storage unit 108 may store other data, such as authentication or credential data that may include user names, passwords, and biometric data associated with system administrators.

In addition, it should be noted that network data processing system 100 may include any number of additional server devices, client devices, and other devices not shown. Program code located in network data processing system 100 may be stored on a computer readable storage medium and downloaded to a computer or other data processing device for use. For example, program code may be stored on a computer readable storage medium on server 104 and downloaded to client device 110 over network 102 for use on client device 110.

In the depicted example, network data processing system 100 may be implemented as a number of different types of communication networks, such as, for example, an internet, an intranet, a local area network (LAN), and a wide area network (WAN). FIG. 1 is intended as an example, and not as an architectural limitation for the different illustrative embodiments.

With reference now to FIG. 2, a diagram of a data processing system is depicted in accordance with an illustrative embodiment. Data processing system 200 is an example of a computer, such as server 104 or client 110 in FIG. 1, in which computer readable program code or program instructions implementing processes of illustrative embodiments may be located. In this illustrative example, data processing system 200 includes communications fabric 202, which provides communications between processor unit 204, memory 206, persistent storage 208, communications unit 210, input/output (I/O) unit 212, and display 214.

Processor unit 204 serves to execute instructions for software applications and programs that may be loaded into memory 206. Processor unit 204 may be a set of one or more hardware processor devices or may be a multi-processor core, depending on the particular implementation. Further, processor unit 204 may be implemented using one or more heterogeneous processor systems, in which a main processor is present with secondary processors on a single chip. As another illustrative example, processor unit 204 may be a symmetric multi-processor system containing multiple processors of the same type.

Memory 206 and persistent storage 208 are examples of storage devices 216. A computer readable storage device is any piece of hardware that is capable of storing information, such as, for example, without limitation, data, computer readable program code in functional form, and/or other suitable information either on a transient basis and/or a persistent basis. Further, a computer readable storage device excludes a propagation medium. Memory 206, in these examples, may be, for example, a random access memory, or any other suitable volatile or non-volatile storage device. Persistent storage 208 may take various forms, depending on the particular implementation. For example, persistent storage 208 may contain one or more devices. For example, persistent storage 208 may be a hard drive, a flash memory, a rewritable optical disk, a rewritable magnetic tape, or some combination of the above. The media used by persistent storage 208 may be removable. For example, a removable hard drive may be used for persistent storage 208.

In this example, persistent storage 208 stores fraudulent transaction identifier 218. Fraudulent transaction identifier 218 monitors financial transaction data to identify and block fraudulent financial transactions by generating scores for current financial transactions. Instead of or in addition to blocking the identified transactions, fraudulent transaction identifier 218 may forward the identified transactions to an appropriate fraud risk management system. In this example, fraudulent transaction identifier 218 includes transaction log data 220, transaction payment accounts 222, transaction payment relationship graph component 224, graph feature extraction component 226, transaction scoring component 228, and fraudulent transaction evaluation component 230. However, it should be noted that the data and components included in fraudulent transaction identifier 218 are intended as examples only and not as limitation on different illustrative embodiments. For example, fraudulent transaction identifier 218 may include more or fewer data or components than illustrated. For example, two or more components may be combined into a single component.

Transaction log data 220 may be, for example, transaction log data of financial transactions performed on and received from a set of one or more client devices via a network, such as transaction log data 116, transaction log data 118, and/or transaction log data 120 received from client device 110, client device 112, and/or client device 114 via network 102 in FIG. 1. Fraudulent transaction identifier 218 may obtain transaction log data 220 from one-or-more channels of financial transactions or transaction channels that may include, for example, point-of-sale terminals, automated teller machines, credit card account computers, bank account computers, online purchase log computers, mobile phone payment computers, and the like. Alternatively, transaction log data 220 may be transaction log data of financial transactions performed on data processing system 200.

Transaction payment accounts 222 list financial accounts corresponding to the financial transactions associated with transaction log data 220. For example, transaction payment accounts 222 may include both source or paying financial accounts and destination or receiving financial accounts involved in financial transactions listed in transaction log data 220.

Transaction payment relationship graph component 224 retrieves account transaction data 232 from transaction log data 220 or directly from financial transaction client devices. Account transaction data 232 identify the particular financial accounts (i.e., source and destination accounts) involved in each financial transaction. Transaction payment relationship graph component 224 generates a set of one or more transaction payment relationship graphs, such as transaction payment relationship graphs 234. A transaction payment relationship graph illustrates payment relationships between vertices corresponding to financial accounts involved in the financial transactions of account transaction data 232. A transaction payment relationship graph may be, for example, a compact transaction graph, an account owner transaction graph, or a multi-partite graph.

Graph feature extraction component 226 extracts graph features 236 from transaction payment relationship graphs 234. In response to transaction scoring component 228 receiving current account transaction data 238, transaction scoring component 228 retrieves information regarding extracted graph features 236 from graph feature extraction component 226 for use in generating fraudulent transaction score 240 for the current financial transaction being performed. After transaction scoring component 228 generates fraudulent transaction score 240 for the current financial transaction, fraudulent transaction evaluation component 230 analyzes fraudulent transaction score 240 to determine whether fraudulent transaction score 240 indicates whether the current financial transaction is fraudulent. For example, fraudulent transaction evaluation component 230 may compare fraudulent transaction score 240 to fraudulent transaction threshold level values 242 to determine whether the current financial transaction is fraudulent. If fraudulent transaction score 240 is equal to or greater than one of fraudulent transaction threshold level values 242, than fraudulent transaction evaluation component 230 determines that the current financial transaction is fraudulent.

In response to fraudulent transaction evaluation component 230 determining that the current financial transaction is fraudulent, fraudulent transaction evaluation component 230 may utilize, for example, fraudulent transaction policies 244 to determine which action to take regarding the current financial transaction. For example, fraudulent transaction policies 244 may direct fraudulent transaction evaluation component 230 to block any current financial transaction with a fraudulent transaction score equal to or greater than a fraudulent transaction threshold level value. Alternatively, fraudulent transaction policies 244 may direct fraudulent transaction evaluation component 230 to mitigate a risk associated with the current financial transaction with a fraudulent transaction score equal to or greater than a fraudulent transaction threshold level value by sending a notification to an owner of the source or paying financial account. Fraudulent transaction evaluation component 230 stores fraudulent transaction data 246. Fraudulent transaction data 246 lists all fraudulent financial transactions previously identified by fraudulent transaction evaluation component 230 for reference by fraudulent transaction identifier 218.

Communications unit 210, in this example, provides for communication with other computers, data processing systems, and devices via a network, such as network 102 in FIG. 1. Communications unit 210 may provide communications using both physical and wireless communications links. The physical communications link may utilize, for example, a wire, cable, universal serial bus, or any other physical technology to establish a physical communications link for data processing system 200. The wireless communications link may utilize, for example, shortwave, high frequency, ultra high frequency, microwave, wireless fidelity (Wi-Fi), bluetooth technology, global system for mobile communications (GSM), code division multiple access (CDMA), second-generation (2G), third-generation (3G), fourth-generation (4G), 4G Long Term Evolution (LTE), LTE Advanced, or any other wireless communication technology or standard to establish a wireless communications link for data processing system 200.

Input/output unit 212 allows for the input and output of data with other devices that may be connected to data processing system 200. For example, input/output unit 212 may provide a connection for user input through a keypad, a keyboard, a mouse, and/or some other suitable input device. Display 214 provides a mechanism to display information to a user and may include touch screen capabilities to allow the user to make on-screen selections through user interfaces or input data, for example.

Instructions for the operating system, applications, and/or programs may be located in storage devices 216, which are in communication with processor unit 204 through communications fabric 202. In this illustrative example, the instructions are in a functional form on persistent storage 208. These instructions may be loaded into memory 206 for running by processor unit 204. The processes of the different embodiments may be performed by processor unit 204 using computer implemented program instructions, which may be located in a memory, such as memory 206. These program instructions are referred to as program code, computer usable program code, or computer readable program code that may be read and run by a processor in processor unit 204. The program code, in the different embodiments, may be embodied on different physical computer readable storage devices, such as memory 206 or persistent storage 208.

Program code 248 is located in a functional form on computer readable media 250 that is selectively removable and may be loaded onto or transferred to data processing system 200 for running by processor unit 204. Program code 248 and computer readable media 250 form computer program product 252. In one example, computer readable media 250 may be computer readable storage media 254 or computer readable signal media 256. Computer readable storage media 254 may include, for example, an optical or magnetic disc that is inserted or placed into a drive or other device that is part of persistent storage 208 for transfer onto a storage device, such as a hard drive, that is part of persistent storage 208. Computer readable storage media 254 also may take the form of a persistent storage, such as a hard drive, a thumb drive, or a flash memory that is connected to data processing system 200. In some instances, computer readable storage media 254 may not be removable from data processing system 200.

Alternatively, program code 248 may be transferred to data processing system 200 using computer readable signal media 256. Computer readable signal media 256 may be, for example, a propagated data signal containing program code 248. For example, computer readable signal media 256 may be an electro-magnetic signal, an optical signal, and/or any other suitable type of signal. These signals may be transmitted over communication links, such as wireless communication links, an optical fiber cable, a coaxial cable, a wire, and/or any other suitable type of communications link. In other words, the communications link and/or the connection may be physical or wireless in the illustrative examples. The computer readable media also may take the form of non-tangible media, such as communication links or wireless transmissions containing the program code.

In some illustrative embodiments, program code 248 may be downloaded over a network to persistent storage 208 from another device or data processing system through computer readable signal media 256 for use within data processing system 200. For instance, program code stored in a computer readable storage media in a data processing system may be downloaded over a network from the data processing system to data processing system 200. The data processing system providing program code 248 may be a server computer, a client computer, or some other device capable of storing and transmitting program code 248.

The different components illustrated for data processing system 200 are not meant to provide architectural limitations to the manner in which different embodiments may be implemented. The different illustrative embodiments may be implemented in a data processing system including components in addition to, or in place of, those illustrated for data processing system 200. Other components shown in FIG. 2 can be varied from the illustrative examples shown. The different embodiments may be implemented using any hardware device or system capable of executing program code. As one example, data processing system 200 may include organic components integrated with inorganic components and/or may be comprised entirely of organic components excluding a human being. For example, a storage device may be comprised of an organic semiconductor.

As another example, a computer readable storage device in data processing system 200 is any hardware apparatus that may store data. Memory 206, persistent storage 208, and computer readable storage media 254 are examples of physical storage devices in a tangible form.

In another example, a bus system may be used to implement communications fabric 202 and may be comprised of one or more buses, such as a system bus or an input/output bus. Of course, the bus system may be implemented using any suitable type of architecture that provides for a transfer of data between different components or devices attached to the bus system. Additionally, a communications unit may include one or more devices used to transmit and receive data, such as a modem or a network adapter. Further, a memory may be, for example, memory 206 or a cache such as found in an interface and memory controller hub that may be present in communications fabric 202.

Illustrative embodiments are based on the hypothesis that a successful payment for a financial transaction between two financial accounts establishes a trust relationship between the two accounts and the trust relationship relies only on the entities making the successful payment. The trust relationship between the two accounts does not depend on the type of transaction channel used to perform the financial transaction or on any other parameter corresponding to the financial transaction. A source or paying account “trusts” the destination or receiving accounts or entities that the source account pays directly most often and greatest amounts transferred.

Illustrative embodiments may utilize this or a similar “trust model” to identify and graphically depict trust relationships between financial accounts. Payment relationships define a community for each account comprising a set of one or more accounts with which a particular account performs financial transactions on a regular basis. Illustrative embodiments may flag financial accounts or transactions outside a defined community for a particular account as anomalous and potentially fraudulent.

For example, illustrative embodiments may aggregate financial transaction data occurring in various different types of transaction channels, such as automated teller machines, credit cards, and mobile phone payments, into a single graph that represents payment relationships. Illustrative embodiments use features extracted from the constructed transaction payment relationship graph to subsequently score other transactions. Illustrative embodiments utilize the transaction scores to identify fraudulent payments.

Thus, illustrative embodiments provide a transaction channel independent mechanism for detecting transaction fraud by utilizing an extracted set of features based on relationships between account vertices in a transaction payment relationship graph, which increases the accuracy of transaction fraud detection. Illustrative embodiments collect, aggregate, and analyze transaction log data from one or more different types of transaction channels, such as point-of-sale terminals, automated teller machines transactions, online payments, mobile payments, and the like. Illustrative embodiments include all transaction and payment systems, which have an auditable “paper trail” and can be uniquely associated with a particular account. Illustrative embodiments generate transaction payment relationship graphs using the collected transaction log data to capture transaction payment relationships during a set of one or more periods of defined time intervals that are of interest.

Illustrative embodiments may utilize various methods to generate transaction payment relationship graph representations from the collected transaction log data, with one goal of aggregating the transaction log data occurring in various different types of transaction channels, such as, for example, automated teller machine transactions, credit card transactions, person-to-person payment transactions, point-of-sale terminal transactions, and the like, into a single transaction payment relationship graph, which represents payment relationships between account vertices within the graph. Illustrative embodiments identify and extract features corresponding to transactions within the graph to score subsequent or current financial transactions to detect whether a particular current financial transaction is fraudulent.

The transaction log data from the various different types of transaction channels may contain the following information: 1) identification of a source account for a transaction from which monetary funds are taken to pay for the transaction and identification of an owner or owners corresponding to the source account (Illustrative embodiments assume the source account to be non-null having available funds to execute a financial transaction); 2) identification of a destination account, which receives payment from the source account, for the transaction and identification of an owner corresponding to the destination account (A destination for a transaction may include, for example, a point-of-sale terminal, an automated teller machine, or other specially designated values for other specific transaction channels. Illustrative embodiments can map these special destinations to a destination account through any arbitrary means. For example, illustrative embodiments associate the point-of-sale terminal with an account of the merchant owning the point-of-sale terminal or associates an automated teller machine destination with a special “automated teller machine” account which is associated with each account); 3) an indication of whether a transaction was a credit or debit transaction; 4) a timestamp for the transaction (Illustrative embodiments may utilize the timestamp for each transaction channel to assist in generating a transaction payment relationship graph. Many possible timestamps associated with a transaction may exist, such as, for example, a timestamp for when the transaction occurred, a timestamp for when the transaction was recorded, a timestamp for when monetary funds where taken from the source account and transmitted to the destination account, a timestamp for when the transaction was officially considered committed, and any such similar timestamp. To construct a transaction payment relationship graph, illustrative embodiments choose one ‘canonical’ timestamp which may be different for each channel and use that timestamp); and 5) a transaction amount for each transaction in a currency, such as dollars, euros, and the like.

Besides the transaction log data mentioned above, the transaction log data also may include other data that capture finer details about the accounts involved in a particular transaction, the specific type of transaction, and/or information regarding the specific type of channel used to conduct the transaction. Illustrative embodiments may leverage this optional data to augment the process for transaction scoring.

Some examples of this optional data are as follows. Information regarding the source account and/or the destination account. For example, the information regarding the accounts may include the type of accounts, a location of an account in the case of point-of-sale terminals or automated teller machines, or any other pertinent account information. It is easy to see how illustrative embodiment may utilize such optional data in fraudulent transaction scoring. For example, illustrative embodiments may customize every fraud scoring method to consider only financial transactions of a certain type. Similarly, illustrative embodiments may utilize location information to score a financial transaction. For example, illustrative embodiments may utilize an impossible geography analytic to determine whether a set of two or more financial transactions performed at different automated teller machine at different locations are fraudulent.

Further, the optional data may include information about a particular transaction, such as, for example, whether the particular transaction is a foreign transaction. Illustrative embodiments may utilize all features corresponding to a particular transaction in fraud scoring. Furthermore, the optional data may include information regarding a particular transaction channel used to conduct the financial transaction, such as channel specific information that is captured along with each channel. Illustrative embodiments may utilize such information to annotate a particular transaction with features. Examples of transaction channel specific features may include details of the computer used to perform an online banking transaction, details of the network, such as internet protocol (IP) address, and the like.

One set of illustrative embodiments consumes such transaction log data arriving from multiple transaction channels, preferably in a real-time streaming manner, and generate a set of one or more transaction payment relationship graphs. Illustrative embodiments utilize graph features of the set of one or more transaction payment relationship graphs to score subsequent or current financial transactions. For each transaction, illustrative embodiments connect or develop a relationship between the source account and the destination account and label the transaction with features, such as a timestamp corresponding to a particular transaction, the amount of monetary funds involved in the transaction, and any other optional data provided in the transaction log data.

It may be necessary for illustrative embodiments to adjust the transaction log data so that every financial transaction record has a distinct source account and destination account. For example, it is preferable to have a “unique account” to identify each point-of-sale terminal, which illustrative embodiments do by assigning some unique identifying information to each particular point-of-sale terminal, such as the physical location of each particular point-of-sale terminal.

Illustrative embodiments handle automated teller machine transactions differently as automated teller machine transactions represent cash being taken out of a source account and spent anonymously. The approach with automated teller machine transactions is to generate a vertex in a transaction payment relationship graph for each source account and uniquely label the vertex as, for example, “<account-number>.CASH” or using a similar scheme to generate a unique label for each account number's automated teller machine transaction.

One illustrative embodiment generates compact transaction payment relationship graphs wherein each vertex in the graph corresponds to an account, which is labeled with a feature that is an identification number of the account. For each financial transaction, the illustrative embodiment inserts an edge within the graph from the source account vertex to the destination account vertex. The illustrative embodiment labels the inserted edge with a set of features that may include at least a timestamp corresponding to the transaction, an amount of funds transferred in the transaction, and an identification number corresponding to the transaction, if an identification number is available. The illustrative embodiment also may add any optional information corresponding to the transaction or the transaction channel as attributes of the inserted edge. Any optional information that is provided in the transaction log data about the source or destination account is added as an attribute to the respective account vertex. The illustrative embodiment inserts an edge between the source and destination account vertices for each financial transaction between the source and destination accounts and multiple financial transactions result in multiple edge insertions between the source and destination account vertices.

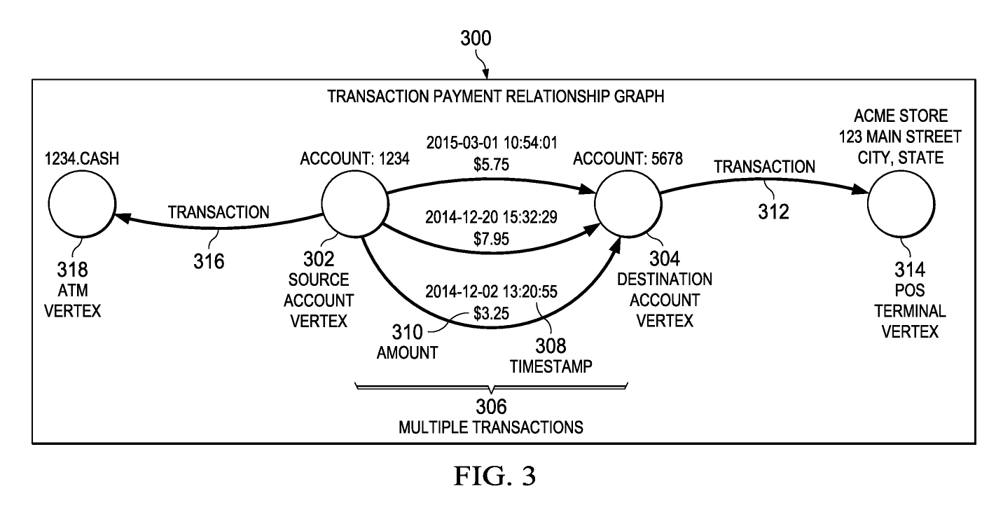

With reference now to FIG. 3, a diagram of an example transaction payment relationship graph showing vertices corresponding to example transactions between accounts is depicted in accordance with an illustrative embodiment. Transaction payment relationship graph 300 may be, for example, one of the transaction payment relationship graphs in transaction payment relationship graphs 234 in FIG. 2.

In this example, transaction payment relationship graph 300 includes source account vertex 302 and destination account vertex 304. Source account vertex 302 represents account “1234” and destination account vertex 304 represents account “5678”. Accounts “1234” and “5678” have multiple transactions 306 performed between them. Illustrative embodiments label each transaction in multiple transactions 306 between accounts “1234” and “5678” with a timestamp, such as timestamp 308 “2014-12-02 13:20:50” and an amount, such as amount 310 “$3.25”.

Transaction payment relationship graph 300 also shows transaction 312 between account “5678” and a point-of-sale terminal, which corresponds to point-of-sale terminal vertex 314. “ACME STORE 123 MAIN STREET, CITY, STATE” is the label for point-of-sale terminal vertex 314 that uniquely identifies the point-of-sale terminal and its physical location. Similarly, account “1234” performs transaction 316 with an automated teller machine corresponding to automated teller machine vertex 318 labeled “1234.CASH”. Transaction 316 indicates that an owner of account “1234” has withdrawn some money from account “1234”. Transactions 316 and 318 do not show an amount or a timestamp, which are features for the edges inserted between the vertices.

An alternative illustrative embodiment may generate a compact owner transaction payment relationship graph. This construct associates with each vertex an owner or owners and associates in the relationship graph an edge in the transaction graph between a vertex corresponding to an owner of a source account and a vertex corresponding to an owner of a destination account, which more directly captures the idea of a payment relationship between account owners. It should be noted that as a simplification, the alternative illustrative embodiment may generate a compact owner transaction payment relationship graph only for accounts where the owner is easily identifiable. In addition, the alternative illustrative embodiment may insert special vertices into the compact owner transaction payment relationship graph for automated teller machine and point-of-sale transactions as described above.

Another alternative illustrative embodiment may generate a complex multi-partite transaction payment relationship graph, which is intended to capture as much information about transactions, transaction channels, and accounts into a single graph. In a complex multi-partite graph representation, vertices may be one of many different types (stored as a feature of a vertex) including the following: 1) transaction vertices, wherein each financial transaction is represented as a vertex; 2) account vertices, representing various financial accounts, including special accounts created for automated teller machines, point-of-sale terminals, and other such transactions; and 3) owner vertices, representing individuals or entities that own the accounts.

In addition, there may be other optional vertex types, such as device vertices that represent fingerprints of devices used to perform online transactions. The devices used to perform the online transactions may be, for example, desktop computers, handheld computer, or smart phones. Account vertices, owner vertices, and device vertices may include a set of one or more features, such as account types, owner addresses, and device characteristics, which illustrative embodiments may add to a transaction payment relationship graph. For each transaction, illustrative embodiments generate a new vertex that includes a set of features, such as, for example, a timestamp corresponding to the transaction, a transaction identification number, and an amount of the transaction. Illustrative embodiments also insert an edge from a source account vertex to a new transaction vertex and insert an edge from the new transaction vertex to a destination account vertex. If the transaction is associated with other vertex types, such as a device vertex, then illustrative embodiments generate a bidirectional edge between the transaction vertex and the associated device vertex or other vertices. Multi-partite transaction payment relationship graphs are more complex, but these types of graphs capture more fine-grained information that some illustrative embodiments may use in fraud scoring analytics.

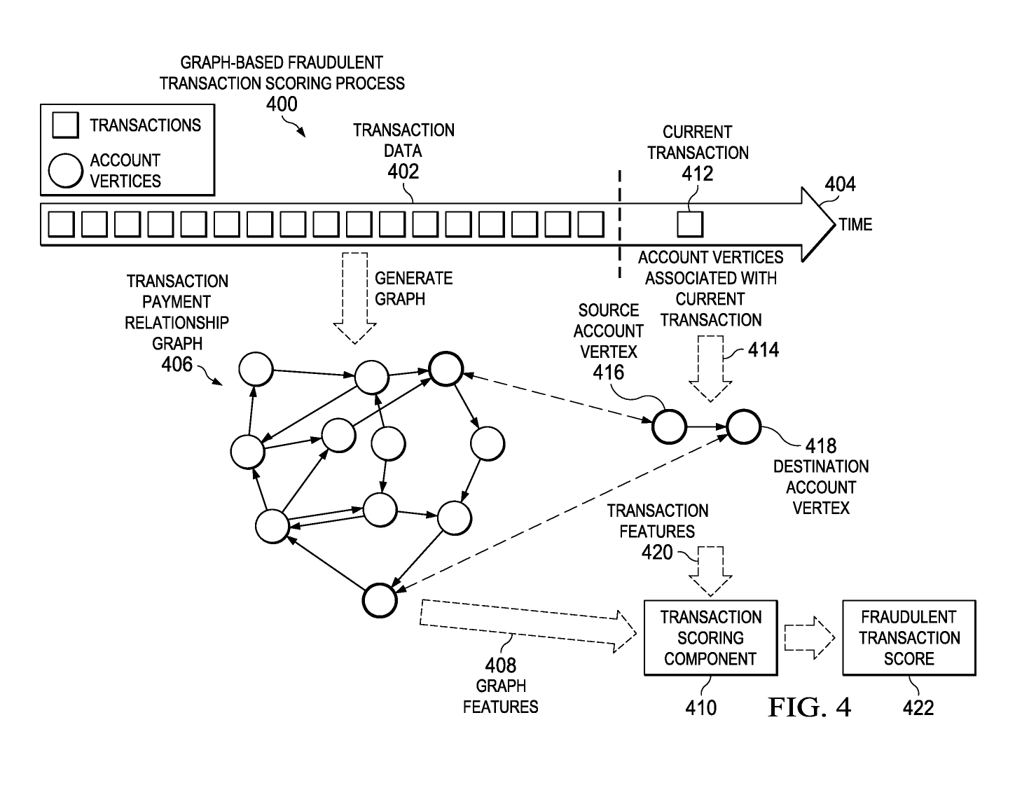

With reference now to FIG. 4, a diagram of an example graph-based fraudulent transaction scoring process is depicted in accordance with an illustrative embodiment. Graph-based fraudulent transaction scoring process 400 may be implemented in a network of data processing systems, such as, for example, network data processing system 100 in FIG. 1. Alternatively, graph-based fraudulent transaction scoring process 400 may be implemented in a single data processing system, such as, for example, data processing system 200 in FIG. 2.

Graph-based fraudulent transaction scoring process 400 illustrates a high-level overview of financial transaction scoring performed by illustrative embodiments. Squares in the diagram of FIG. 4 represent transactions, while circles represent account vertices. Illustrative embodiments divide time into discrete units of time or time intervals to scope the transaction payment relationship graphs generated from transaction data, score transactions, and build ensembles. Illustrative embodiments utilize transaction data 402, which illustrative embodiments aggregate over time, such as time 404, to generate transaction payment relationship graph 406. Transaction data 402 may be, for example, transaction log data 220 in FIG. 2. Transaction payment relationship graph 406 is similar to transaction payment relationship graph 300 in FIG. 3.

Illustrative embodiments generate transaction payment relationship graph 406 based on transaction data 402, which corresponds to financial transactions that occurred in the past. For a current financial transaction to be scored, such as current transaction 412, illustrative embodiments extract graph features 408 corresponding to current transaction 412 from transaction payment relationship graph 406. Illustrative embodiments input information regarding graph features 408 into transaction scoring component 410. In parallel, illustrative embodiments identify account vertices associated with current transaction 414 in transaction payment relationship graph 406. In this example, account vertices associated with current transaction 414 are source account vertex 416 and destination account vertex 418.

Illustrative embodiments extract graph-based transaction features 420 corresponding to source account vertex 416 and destination account vertex 418. Illustrative embodiments also input information regarding extracted graph-based transaction features 420 into transaction scoring component 410. Transaction scoring component 410 outputs fraudulent transaction score 422, which indicates whether current transaction 412 is fraudulent or not. A fraudulent transaction evaluation component, such as fraudulent transaction evaluation component 230 in FIG. 2, may block current transaction 412, or otherwise mitigate current transaction 412, when fraudulent transaction score 422 is greater than or equal to a predefined fraudulent transaction threshold score. The fraudulent transaction evaluation component may mitigate current transaction 412 by interrupting current transaction 412 and sending a notification to an owner of the source or paying account corresponding to source account vertex 416 requesting authorization to proceed with current transaction 412 or to block and cancel current transaction 412.

To score a transaction (t) from a source account (A) to a destination account (B) which correspond to vertices (X) and (Y) relative to a transaction payment relationship graph (G), illustrative embodiments calculate features (F) corresponding to vertices X and Y, and the pair of vertices <X, Y>, relative to the graph G. Calculated features may include, but are not limited to, the following:
1. F_{G}(X) and F_{G}(Y), features corresponding to the vertices X and Y. For example, the number of neighboring vertices or the number of associated edges in the graph G.
2. ΔF_{G1, . . . ,Gn}(X) and ΔF_{G1, . . . ,Gn} (Y), how the features change given a set of different time window transaction graphs G₁ . . . Gₙ that may be taken from different time periods or lengths of transactions.
3. A(F)G(X) and A(F)G(Y), anomaly scores for the features F corresponding to vertices X and Y. For example, a feature, such as the ratio of the number of distinct accounts transacted with and the total monetary value of the transactions may make an account an anomaly compared to other accounts in the graph G.
4. F_{G}<<X,Y>>, features corresponding to the pair of vertices <X, Y> in the graph G. For example, the amount of money that flows from source vertex X corresponding to the source account A to destination vertex Y corresponding to destination account B through another vertex Z.

To score current financial transactions, illustrative embodiments utilize a scoring function, S( ), which takes as input the features extracted from a set of one or more transaction payment relationship graphs for a given current transaction, and outputs a score indicating a level of fraud associated with the given current transaction (i.e., whether the given current transaction is fraudulent or not). Such scoring functions can be defined in either an unsupervised or a supervised manner. Possible examples of supervised scoring function S( ) may include logistic regression or support vector machines. These supervised machine learning systems require a set of labeled transactions (i.e., known instances of fraudulent transactions, such as fraudulent transaction data 246 in FIG. 2) to train a classifier. Once trained, these supervised machine-learning systems can output a fraudulent transaction score for any new current transaction.

Alternatively, if labeled transaction samples are unavailable, illustrative embodiments may utilize an unsupervised machine learning system for the scoring function S( ). An unsupervised machine learning system, such as, for example, a one-class support vector machine, can find transactions that are unusual or different from other transactions. Here, illustrative embodiments may require domain knowledge to give the system a hint on how certain features affect the fraudulent transaction scores, such as positively or negatively.

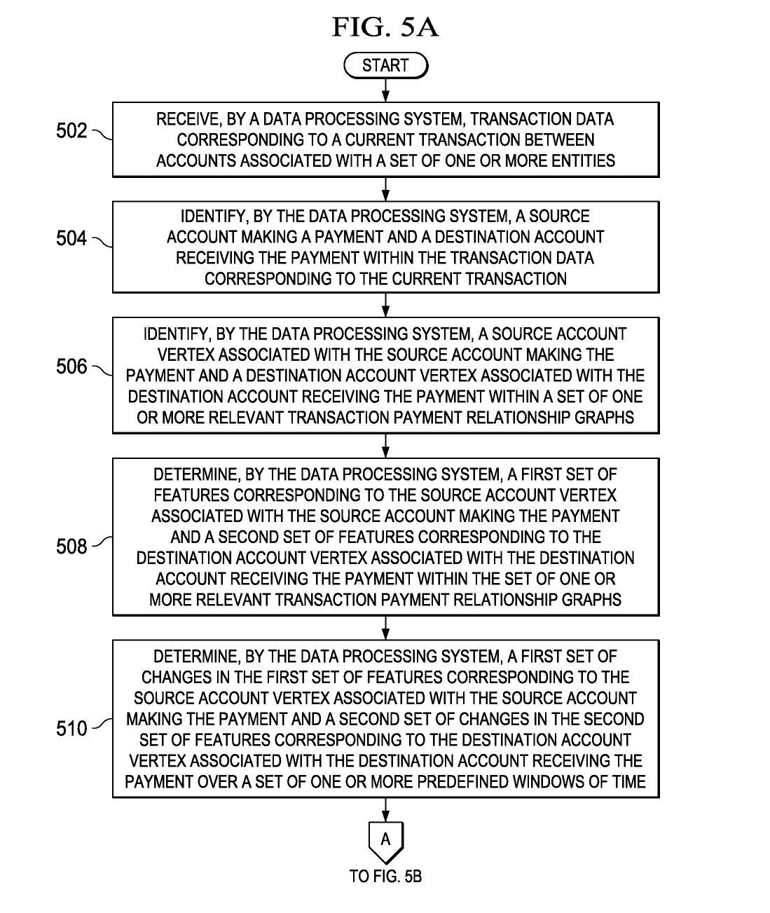

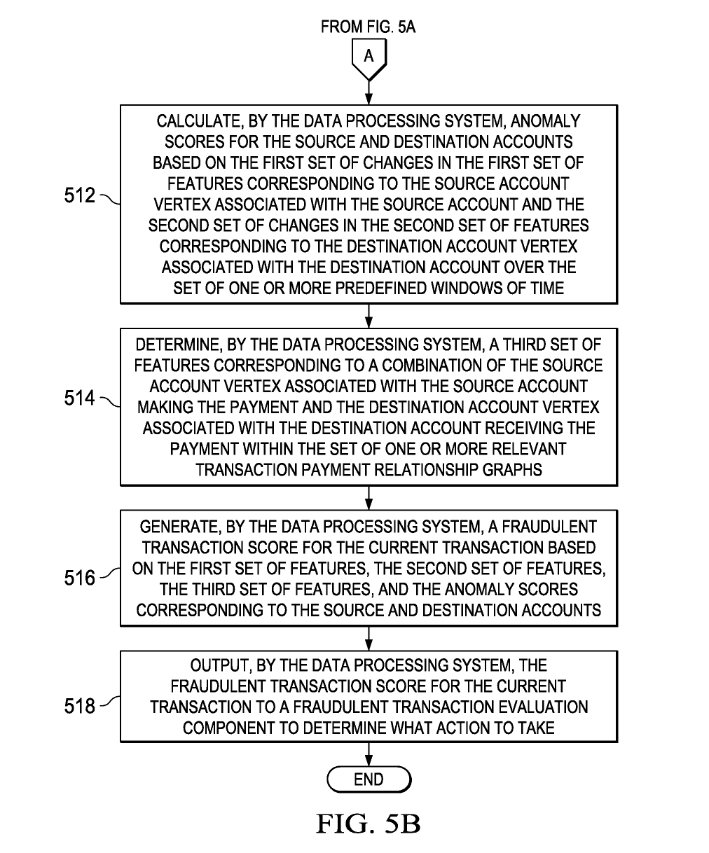

With reference now to FIGS. 5A-5B, a flowchart illustrating a process for fraudulent transaction scoring is shown in accordance with an illustrative embodiment. The process shown in FIGS. 5A-5B may be implemented in a data processing system, such as, for example, server 104 or client 110 in FIG. 1 or data processing system 200 in FIG. 2.

The process begins when the data processing system receives transaction data corresponding to a current transaction between accounts associated with a set of one or more entities (step 502). The data processing system identifies a source account making a payment and a destination account receiving the payment within the transaction data corresponding to the current transaction (step 504). In addition, the data processing system identifies a source account vertex associated with the source account making the payment and a destination account vertex associated with the destination account receiving the payment within a set of one or more relevant transaction payment relationship graphs (step 506).

Subsequently, the data processing system determines a first set of features corresponding to the source account vertex associated with the source account making the payment and a second set of features corresponding to the destination account vertex associated with the destination account receiving the payment within the set of one or more relevant transaction payment relationship graphs (step 508). Further, the data processing system determines a first set of changes in the first set of features corresponding to the source account vertex associated with the source account making the payment and a second set of changes in the second set of features corresponding to the destination account vertex associated with the destination account receiving the payment over a set of one or more predefined windows of time (step 510).

Afterward, the data processing system calculates anomaly scores for the source and destination accounts based on the first set of changes in the first set of features corresponding to the source account vertex associated with the source account and the second set of changes in the second set of features corresponding to the destination account vertex associated with the destination account over the set of one or more predefined windows of time (step 512). In addition, the data processing system determines a third set of features corresponding to a combination of the source account vertex associated with the source account making the payment and the destination account vertex associated with the destination account receiving the payment within the set of one or more relevant transaction payment relationship graphs (step 514).

Afterward, the data processing system generates a fraudulent transaction score for the current transaction based on the first set of features, the second set of features, the third set of features, and the anomaly scores corresponding to the source and destination accounts (step 516). Then, the data processing system outputs the fraudulent transaction score for the current transaction to a fraudulent transaction evaluation component to determine what action to take (step 518). Thereafter, the process terminates.

To score any current financial transaction, the data processing system evaluates the transaction against features extracted from the set of relevant transaction payment relationship graphs that represent previous financial transactions that occurred in the past. There are two different ways of defining such a prior time window for a transaction that occurred at time (t). A first approach is to consider any transaction that occurs in the time window (t−δ,t). The parameter δ defines the length of the time window used to generate the set of relevant transaction payment relationship graphs. This first approach is referred to as real-time scoring.

An alternative approach is to consider any transaction that occurs in the time window [n*(└t/n┘−i), n*(└t/n┘−j)], i>j≧1. This latter approach is referred to as discrete time scoring. Here, the parameter (n) specifies the level of granularity for the time window, such as an hour, a day, or a week. The parameters (i) and (j) specify how far back a time window goes (i), and how long the time window is (i−j units of length n). The floor function (└t/in┘) allows the data processing system to determine which discrete time window a particular transaction belongs to. The data processing system can score any transaction based on the set of relevant transaction payment relationship graphs generated for many values of the different parameters n, i, and j. For example, the data processing system may generate transaction payment relationship graphs based on all transactions from a one, two, and four week window length, and these graphs may pre-date the transaction being scored by one, two, three, and four weeks.

Yet another approach is to use a hybrid of the two approaches above. For example, the starting time may be discrete and fixed, such as starting at midnight of each new day, while the endpoint may include any transaction up to the current time. Still yet another approach is to base the score on a fixed number of transactions. For example, the last 10,000,000 transactions, regardless of the time when the transactions were executed.

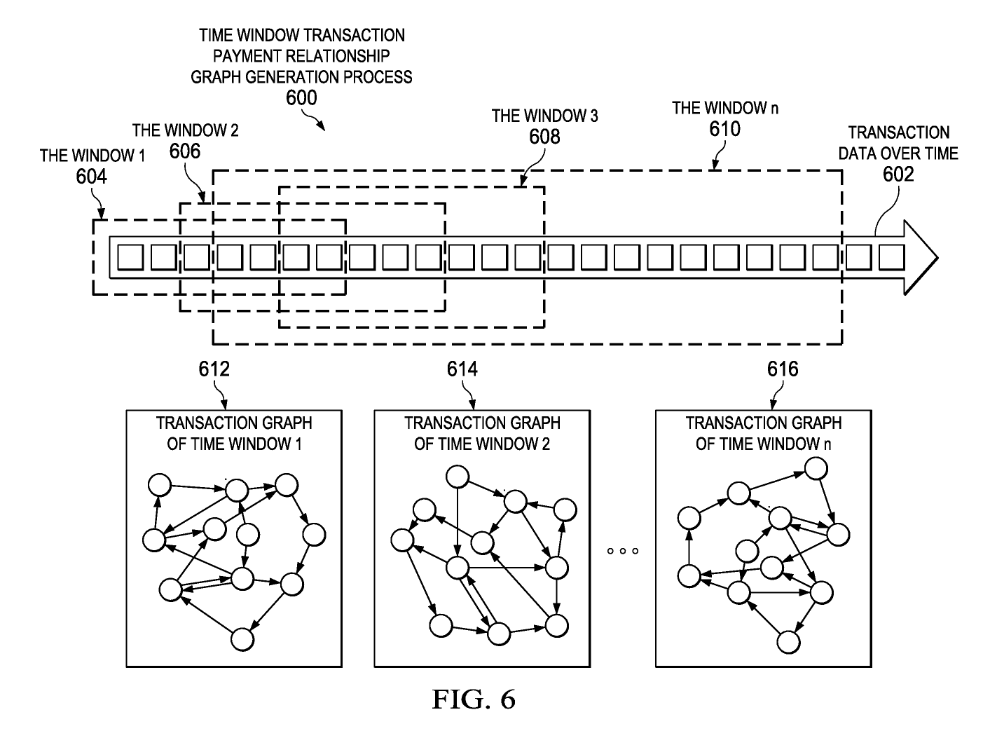

With reference now to FIG. 6, a diagram of an example of time window transaction payment relationship graph generation process is depicted in accordance with an illustrative embodiment. Time window transaction payment relationship graph generation process 600 may be implemented in a data processing system, such as, for example, server 104 or client 110 in FIG. 1 or data processing system 200 in FIG. 2.

Time window transaction payment relationship graph generation process 600 illustrates transaction data over time 602 shown within discrete units or intervals of time, such as time window 1 604, time window 2 606, time window 3 608, and time window n 610. Transaction graph of time window 1 612 illustrates transaction payment relationships between vertices corresponding to transactions performed during time window 1 604. Similarly, transaction graph of time window 2 614 illustrates transaction payment relationships between vertices corresponding to transactions performed during time window 2 606 and transaction graph of time window n 616 illustrates transaction payment relationships between vertices corresponding to transactions performed during time window n 610.

A time window transaction payment relationship graph for some defined time period, such as, for example, one week, may remain valid for transaction fraud scoring for a long interval into the future with different semantics. For example, a one week time window may represent an immediately proceeding time window (j=1) for some set of transactions and may represent an “older” one week time window (j>1) for a set of later transactions. A data processing system can generate features and fraudulent transaction scores for a given current transaction from multiple time window payment relationship graphs of different time window lengths and ages and combine the features and scores using, for example, ensemble methods. An ensemble consists of a set of individually trained classifiers, such as neural networks or decision trees, whose results are combined to improve prediction accuracy of a machine learning algorithm.

Some transactions may be periodic, such as purchasing morning coffee on a daily basis, paying the rent or mortgage on a monthly basis, paying estimated taxes on a quarterly basis. Other transactions may be more random and not performed on any type of a periodic basis, such as purchasing a chain saw. The data processing system will “age” older transactions and use the aged transaction data to score many transactions into the future with different semantic meanings. In addition, the data processing system will generate new time window transaction payment relationship graphs as transactions enter the data processing system and time advances.

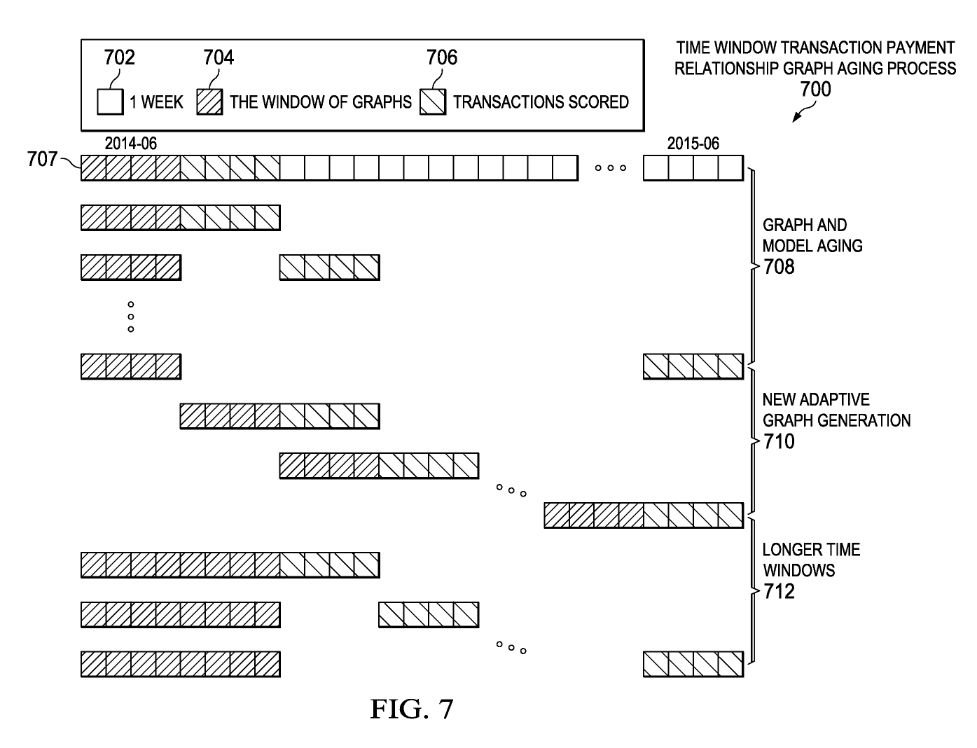

With reference now to FIG. 7, a diagram of an example of a time window transaction payment relationship graph aging process to score current transactions is depicted in accordance with an illustrative embodiment. Time window transaction payment relationship graph aging process 700 may be implemented in a data processing system, such as, for example, server 104 or client 110 in FIG. 1 or data processing system 200 in FIG. 2.

Time window transaction payment relationship graph aging process 700 illustrates how a data processing system may utilize discrete units of time to generate time window transaction payment relationship graphs of different lengths and how these graphs may age. In this example, each block or square is equal to a fixed span time interval, such as 1 week 702. However, it should be noted that different illustrative embodiments may utilize any time interval, such as, for example, 1 second, 1 minute, 1 day, 1 month, et cetera. Time window of graphs 704 represents the number of one week time intervals that comprise a time window transaction payment relationship graph. In the example of line 707, the data processing system generates the time window transaction payment relationship graph using the transaction data contained in four one week time intervals. Transactions scored 706 represents the number of one week time intervals that the data processing system scores transactions using time window of graphs 704. In the example of line 707, the data processing system scores four one week time intervals of transactions using the information contained in the generated time window transaction payment relationship graph based on the previous four one week time intervals.

Also in this example, graph and model aging 708 illustrates aging and scoring of transactions from “2014-06” to “2015-06” (i.e., over a one year period) using transaction data from the same window of time. New adaptive graph generation 710 illustrates how the data processing system may utilize transaction data from different windows of time to score transactions. Longer time windows 712 illustrates how the data processing system may utilize longer periods of time, such as eight one week time intervals, for a time window to score transactions.

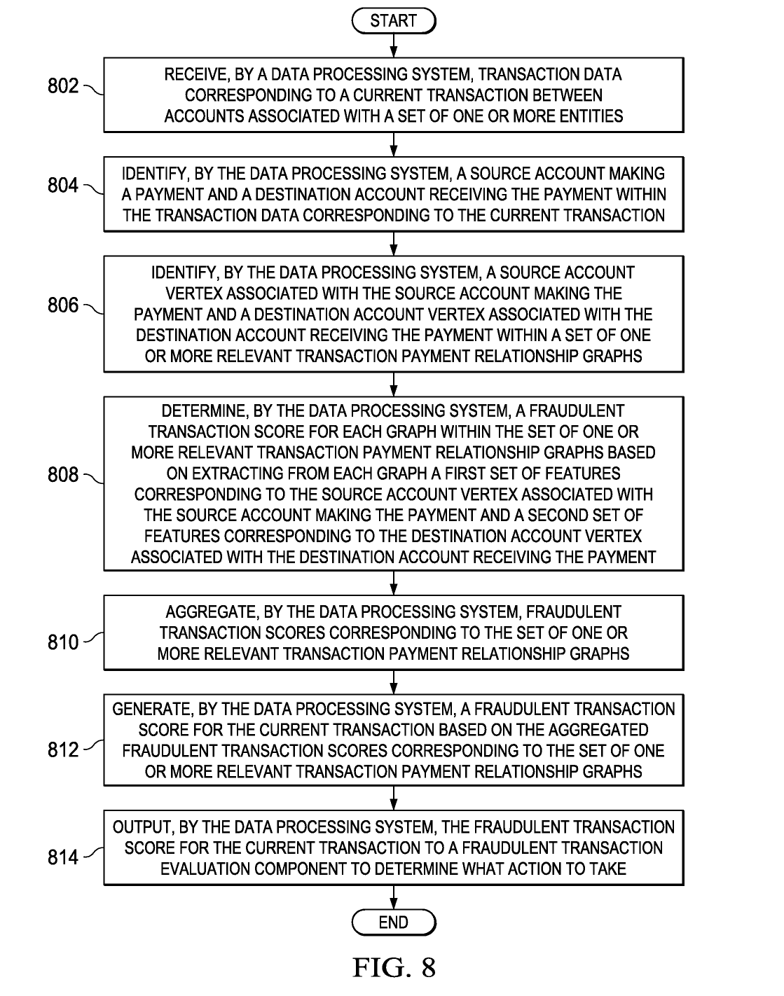

To score a final transaction, the data processing system may utilize ensemble methods. This can be accomplished in two ways. The first way, the data processing system aggregates transaction features from multiple time window transaction payment relationship graphs. The second way, the data processing system aggregates fraudulent transaction scores from multiple time window transaction payment relationship graphs. In the first method, let F₁ be the features extracted from graph G₁ for a transaction t, F₂ the features extracted from graph G₂ for transaction t, and so on. The data processing system calculates the fraudulent transaction score as S(F₁∥F₂ . . . ∥Fₙ), where ∥ is a concatenation function for the union of the features. In the second method, the data processing system scores a transaction with respect to each transaction payment relationship graph, individually, and then combines the scores from each individual graph. For example, ε(S₁ (F₁), S₂ (F₂), . . . Sₙ (Fₙ)), where ε( ) is an ensemble method used to combine fraudulent transaction scores. This second method may utilize any aggregation function or machine learning algorithm, such as logistic regression or support vector machines, which may weight and aggregate the individual scores accordingly. An ensemble scoring process is shown in FIG. 8.

With reference now to FIG. 8, a flowchart illustrating a process for aggregating fraudulent transaction scores corresponding to a set of one or more relevant transaction payment relationship graphs based on features extracted from the set of relevant transaction payment relationship graphs is shown in accordance with an illustrative embodiment. The process shown in FIG. 8 may be implemented in a data processing system, such as, for example, server 104 or client 110 in FIG. 1 and data processing system 200 in FIG. 2.

The process begins when the data processing system receives transaction data corresponding to a current transaction between accounts associated with a set of one or more entities (step 802). The data processing system identifies a source account making a payment and a destination account receiving the payment within the transaction data corresponding to the current transaction (step 804). In addition, the data processing system identifies a source account vertex associated with the source account making the payment and a destination account vertex associated with the destination account receiving the payment within a set of one or more relevant transaction payment relationship graphs (step 806).

Afterward, the data processing system determines a fraudulent transaction score for each graph within the set of one or more relevant transaction payment relationship graphs based on extracting from each graph a first set of features corresponding to the source account vertex associated with the source account making the payment and a second set of features corresponding to the destination account vertex associated with the destination account receiving the payment (step 808). Further, the data processing system aggregates fraudulent transaction scores corresponding to the set of one or more relevant transaction payment relationship graphs (step 810).

Subsequently, the data processing system generates a fraudulent transaction score for the current transaction based on the aggregated fraudulent transaction scores corresponding to the set of one or more relevant transaction payment relationship graphs (step 812). The data processing system also outputs the fraudulent transaction score for the current transaction to a fraudulent transaction evaluation component to determine what action to take (step 814). Thereafter, the process terminates.

It should be noted that the data processing system may utilize a number of features of transaction payment relationship graphs for fraudulent transaction detection. In each case a scoring feature S, can be used to score the transaction. Each feature is now described along with a representative scoring feature based on the feature.

Shortest edge path between vertices is one feature of a transaction payment relationship graph. A definition of a community of account vertices may be based on the shortest edge path from a source account vertex corresponding to a particular transaction to its intended destination account vertex. Vertices within a shortest edge path comprising a length of one edge are the vertices that the source account has had prior transactions with and, therefore, are trusted account vertices. By extension, vertices within a shortest edge path comprising a length of two edges may be considered trusted, perhaps a little less so, since the destination account vertex has transacted business with another account vertex the source account vertex has transacted business with. With this intuition, as the shortest edge path to the destination account vertex increases from the source account vertex, a lower degree of trust exists between the source account and the destination account. Thus, a transaction associated with a destination account vertex that is more than ten edge hops away from the source account vertex can be considered as having a very low level of trust between the source and destination accounts. There are many variants of this definition that also capture a similar concept of trust or closeness between account vertices in a transaction payment relationship graph.

Shortest reverse edge path indicates the length of the shortest edge path from the destination account vertex to the source account vertex. The intuition here is that in transaction payment relationship graphs the level of trust between accounts can be symmetric and, thus, the closeness of the source account vertex to the destination account vertex can be indicative of a trusted transaction. Shortest undirected edge path, a third variant in measuring closeness of two vertices, is the shortest edge path when edge directions are ignored (i.e., the undirected shortest edge path between the two vertices). It should be noted that while a direct edge path from the source account vertex to the destination account vertex, or the reverse, may not exist, an undirected shortest edge path may exist between the source and destination account vertices.

A fourth variant is shortest distance between source and destination account vertices. Instead of computing the shortest edge path (i.e., the least number of edges between transaction endpoints), a data processing system may take into account weights assigned to edges. The weight of an edge defines how much trust exists between two incident vertices. The weight may be defined in many ways. For example, an edge weight may be based on the number of transactions between two vertices, the total monetary amount incoming and outgoing of all transactions between the two vertices, physical geodesic distance, or any other metric that measures closeness or trust.

To score a transaction for fraud, a data processing system may consider the shortest distance between transaction endpoint vertices (i.e., the path with the smallest sum of the weights of edges on the path). Thus, the weight of an edge is defined to be inversely proportional to the trust level value between the transaction endpoint vertices (i.e., the number of transactions between the two endpoint vertices, the total monetary amount corresponding to transactions between the two endpoint vertices, et cetera). For example, if a vertex has k number of outgoing edge neighbors and the trust level value for the neighbors (e.g., number of transactions, monetary value of all transactions, et cetera) are v₁, v₂, . . . , vₖ, then the weights of the edges will be inversely proportional to vⱼ. One particular example of such a function is ωᵢ=1−vᵢ/Σⱼvⱼ. A data processing system may calculate weighted versions of the shortest edge path, shortest reverse edge path, and undirected edge path in a similar fashion for generating fraudulent transactions scores.

Given a particular transaction from a source account A to a destination account B, the data processing system first finds the two vertices corresponding to these two accounts, say X and Y, respectively. Let d₁, r₁, and u₁ be the lengths of the shortest edge path, the shortest reverse edge path, and shortest undirected edge path between vertices X and Y, respectively. Similarly let d₂, r₂ and u₂ be the shortest distance, shortest reverse distance, and shortest undirected distance between vertices X and Y, respectively. The data processing system may utilize all six of the values above to score the particular transaction for fraud. However, it should be noted that alternative illustrative embodiments may utilize any combination of the values above for transaction scoring. In general, a level of suspicion for fraud corresponding to a transaction is defined as any function that is directly proportional to these six values above (i.e., the greater these values become, the greater the level of suspicion that a transaction is fraudulent). Specific instances of such functions can be those that grow slowly initially and exponentially increase after some value, say d₁=5. Another function that most directly captures this is a threshold function: for example, score is 0 if d₁<6 and d₂<6 and score is 1 if not. Variants can be defined based on the other values or any combination of these functions.

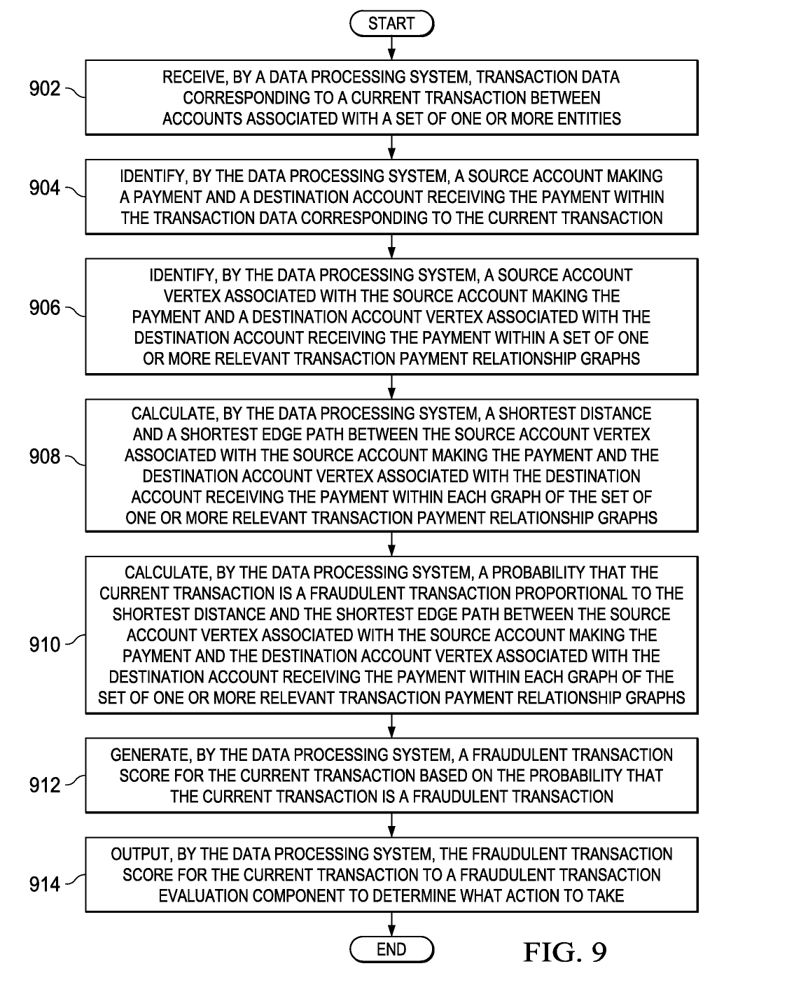

With reference now to FIG. 9, a flowchart illustrating a process for generating a fraudulent transaction score using a shortest distance and a shortest edge path between a source account vertex and a destination account vertex corresponding to a transaction within a set of one or more relevant transaction payment relationship graphs is shown in accordance with an illustrative embodiment. The process shown in FIG. 9 may be implemented in a data processing system, such as, for example, server 104 or client 110 in FIG. 1 and data processing system 200 in FIG. 2.

The process begins when the data processing system receives transaction data corresponding to a current transaction between accounts associated with a set of one or more entities (step 902). The data processing system identifies a source account making a payment and a destination account receiving the payment within the transaction data corresponding to the current transaction (step 904). In addition, the data processing system identifies a source account vertex associated with the source account making the payment and a destination account vertex associated with the destination account receiving the payment within a set of one or more relevant transaction payment relationship graphs (step 906).

Further, the data processing system calculates a shortest distance and a shortest edge path between the source account vertex associated with the source account making the payment and the destination account vertex associated with the destination account receiving the payment within each graph of the set of one or more relevant transaction payment relationship graphs (step 908). Furthermore, the data processing system calculates a probability that the current transaction is a fraudulent transaction proportional to the shortest distance and the shortest edge path between the source account vertex associated with the source account making the payment and the destination account vertex associated with the destination account receiving the payment within each graph of the set of one or more relevant transaction payment relationship graphs (step 910).

Afterward, the data processing system generates a fraudulent transaction score for the current transaction based on the probability that the current transaction is a fraudulent transaction (step 912). Then, the data processing system outputs the fraudulent transaction score for the current transaction to a fraudulent transaction evaluation component to determine what action to take (step 914).

Another method for fraud scoring is PageRank. PageRank is a measure of the level of trust associated with an account. PageRank can be contrasted with centrality measures in that PageRank measures quantity and quality values corresponding to incoming transactions to an account. As such, unlike centrality measures, sink vertices may have a high PageRank value.

The PageRank method was originally developed to model the importance of web pages and is used by many search engines for ranking web pages. A data processing system considers accounts with a high PageRank value to be less likely to be fraudulent. In the PageRank method, a source account distributes its own PageRank value to destination accounts it pays, and the algorithm iterates until convergence of PageRank values between accounts.

PR(u)=1−d/N+d Σ_{vεP(u)} PR(v)/|P(v)|, where P(u) is a set of account u pays and d is a damping factor. In traditional PageRanking, a damping factor is used to model the probability that a random web surfer stops on a particular web page. In financial transactions, a similar analogy also applies and the damping factor can be used to model an account savings or paying an account that is not visible and not spending the incoming money. A data processing system may utilize a default damping factor, such as, for example, 0.85, or may utilize a per-account damping factor based on past spending/saving behavior. Finally, the data processing system may utilize PageRank in either an un-weighted form, as described above, or a weighted form. In the weighted form, the data processing system makes the distribution of an account's PageRank to those of its neighboring vertices proportional to the transaction weights. In an alternative illustrative embodiment, the data processing system weights edges between vertices based on the number or frequency of the transactions between the vertices.

Illustrative embodiments may utilize four different versions of PageRank, including forward un-weighted, forward weighted, reverse un-weighted, and reverse weighted. In the reverse versions, the directions of the transaction edges are reversed. The intuition behind reversing the direction of the edges is that accounts that perform many transactions are less likely to be performing fraudulent transactions. Given a particular transaction from source account A to destination account B, let X and Y be the two vertices corresponding to these accounts in the transaction payment relationship graph, respectively. Let RR₁ and WRR₁ be the reverse un-weighted PageRank and reverse weighted PageRank of the source account vertex X of the transaction. Similarly let FR₁ and WFR₁ be the forward un-weighted PageRank and forward weighted PageRank of the destination account vertex Y of the transaction. The data processing system may utilize any scoring function that is inversely proportional to these PageRank values (i.e., the higher the PageRank and weighted PageRank associated with the destination account, the lower the probability that the transaction is fraudulent). Similarly, the higher the reverse PageRank and reverse weighted PageRank associated with the source account, the lower the probability of the transaction being fraudulent. In particular, one example of a scoring function takes thresholds t₁;wt₁ and declares a transaction fraudulent if FR₁<t₁ and WFR₁<wt₂, otherwise, the scoring function declares the transaction safe. Similarly, illustrative embodiments may define a threshold function based on the reverse PageRank of the source account. A third variant may simultaneously apply thresholds to both the reverse PageRanks of the source account and PageRanks of the destination account.

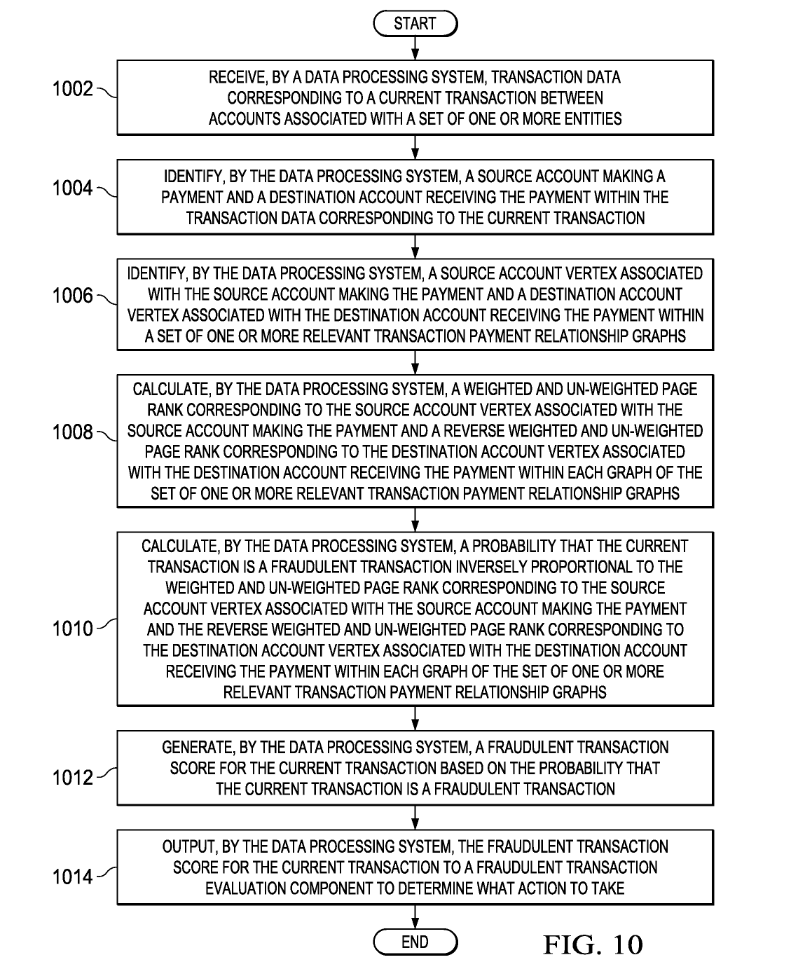

With reference now to FIG. 10, a flowchart illustrating a process for generating a fraudulent transaction score using a PageRank of a source account vertex and a destination account vertex corresponding to a transaction within a set of one or more relevant transaction payment relationship graphs is shown in accordance with an illustrative embodiment. The process shown in FIG. 10 may be implemented in a data processing system, such as, for example, server 104 or client 110 in FIG. 1 and data processing system 200 in FIG. 2.

The process begins when the data processing system receives transaction data corresponding to a current transaction between accounts associated with a set of one or more entities (step 1002). The data processing system identifies a source account making a payment and a destination account receiving the payment within the transaction data corresponding to the current transaction (step 1004). In addition, the data processing system identifies a source account vertex associated with the source account making the payment and a destination account vertex associated with the destination account receiving the payment within a set of one or more relevant transaction payment relationship graphs (step 1006).

Further, the data processing system calculates a weighted and un-weighted PageRank corresponding to the source account vertex associated with the source account making the payment and a reverse weighted and un-weighted PageRank corresponding to the destination account vertex associated with the destination account receiving the payment within each graph of the set of one or more relevant transaction payment relationship graphs (step 1008). Furthermore, the data processing system calculates a probability that the current transaction is a fraudulent transaction inversely proportional to the weighted and un-weighted PageRank corresponding to the source account vertex associated with the source account making the payment and the reverse weighted and un-weighted PageRank corresponding to the destination account vertex associated with the destination account receiving the payment within each graph of the set of one or more relevant transaction payment relationship graphs (step 1010).

Afterward, the data processing system outputs a fraudulent transaction score for the current transaction based on the probability that the current transaction is a fraudulent transaction (step 1012). Then, the data processing system outputs the fraudulent transaction score for the current transaction to a fraudulent transaction evaluation component to determine what action to take (step 1014).

The edges between vertices in the transaction payment relationship graph can be seen as having a capacity equal to the amount of money involved in the transaction. Using this view, a data processing system calculates the maximum monetary flow in the transaction payment relationship graph based from the source account vertex to the destination account vertex, to give the maximum amount of money that flows from the source account vertex to the given destination account vertex. The amount monetary flow from the source account to the destination account can be an indication of how likely money is to be transmitted and, hence, how likely the transaction is to occur.

Another closely related notion that directly measures the likelihood of monetary flow is the notion of normalized flow. Given an edge from source account vertex X to destination account vertex Y, the data processing system replaces the given edge's transaction value with a normalized value, such as, for example, the original transaction value divided by the total value of all transactions originating from source account vertex X. Thus, the normalized weight of an edge to a neighboring vertex is the likelihood that a transaction from source account vertex X goes to destination account vertex Y. For any two vertices (e.g., X and Y), the data processing system may calculate the maximum normalized flow from vertex X to vertex Y. The data processing system may utilize this calculated maximum normalized flow as a measure of the likelihood that a transaction from vertex X to vertex Y will occur.

The data processing system may utilize these notions of flow for fraud scoring because the probability of a transaction being fraudulent is directly proportional to the maximum flow and/or the maximum normalized flow. In particular, given a transaction from source account A to destination account B, corresponding to vertices X and Y, respectively, let f be the maximum flow and nf the normalized maximum flow from source account vertex X to destination account vertex Y. The scoring function may be any function that is inversely proportional to the value of maximum flow f and normalized maximum flow nf. In particular, threshold functions that score a transaction as fraudulent when maximum flow f and/or normalized maximum flow nf fall below a threshold are good examples of scoring functions based on flow.

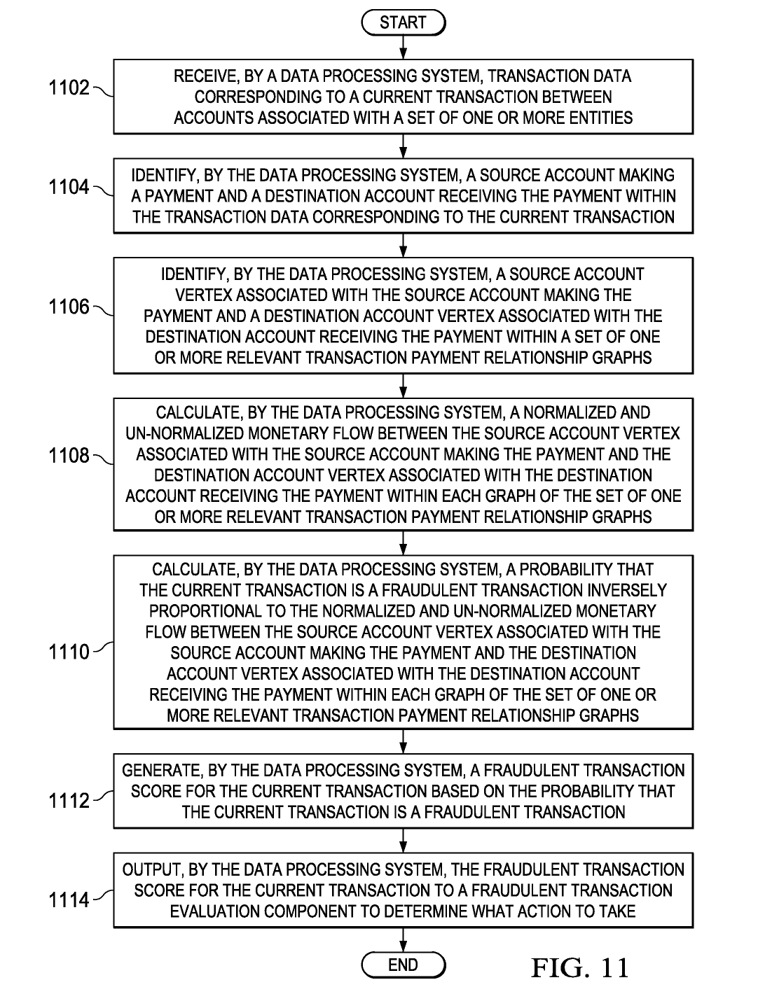

With reference now to FIG. 11, a flowchart illustrating a process for generating a fraudulent transaction score using monetary flow between a source account vertex and a destination account vertex corresponding to a transaction within a set of one or more relevant transaction payment relationship graphs is shown in accordance with an illustrative embodiment. The process shown in FIG. 11 may be implemented in a data processing system, such as, for example, server 104 or client 110 in FIG. 1 and data processing system 200 in FIG. 2.

The process begins when the data processing system receives transaction data corresponding to a current transaction between accounts associated with a set of one or more entities (step 1102). The data processing system identifies a source account making a payment and a destination account receiving the payment within the transaction data corresponding to the current transaction (step 1104). In addition, the data processing system identifies a source account vertex associated with the source account making the payment and a destination account vertex associated with the destination account receiving the payment within a set of one or more relevant transaction payment relationship graphs (step 1106).

Further, the data processing system calculates a normalized and un-normalized monetary flow between the source account vertex associated with the source account making the payment and the destination account vertex associated with the destination account receiving the payment within each graph of the set of one or more relevant transaction payment relationship graphs (step 1108). Furthermore, the data processing system calculates a probability that the current transaction is a fraudulent transaction inversely proportional to the normalized and un-normalized monetary flow between the source account vertex associated with the source account making the payment and the destination account vertex associated with the destination account receiving the payment within each graph of the set of one or more relevant transaction payment relationship graphs (step 1110).

Afterward, the data processing system generates a fraudulent transaction score for the current transaction based on the probability that the current transaction is a fraudulent transaction (step 1112). Then, the data processing system outputs the fraudulent transaction score for the current transaction to a fraudulent transaction evaluation component to determine what action to take (step 1114).

A strongly connected component in a transaction payment relationship graph G is defined as a sub-graph G′, such that an edge path exists for all pairs of vertices X,Y,{X,Y}-⊂G′, an edge path exists from vertex X to vertex Y, and an edge path exists from vertex Y back to vertex X. In financial transaction graphs, this yields a bidirectional flow of money. Intuitively, it implies that a “return path” exists by which money can flow back to the source account. Some fraudulent or malicious accounts will flow money outside of the visible system, or convert the flow of money to an anonymous and untraceable form, such as cash, for spending.

The data processing system may extract several features from the transaction payment relationship graph based on strongly connected components for fraud scoring. First, let c₁ be the strongly connected component of vertex X, let c₂ be the strongly connected component for vertex Y, and let the transaction being scored be from vertex X to vertex Y. When strongly connected component c₁ is the same as the strongly connected component c₂, such that both vertex X and vertex Y are in the same strongly connected component, data processing system could determine that the transaction is less likely to be fraudulent. Assume that n₁ is the number of accounts in strongly connected component c₁ and n₂ is the number of accounts in strongly connected component c₂. If number of accounts n₁ and number of accounts n₂ are large (relative to the total number of accounts) and strongly connected component c₁ is not the same as strongly connected component c₂, then the data processing system could determine that the transaction is more likely to be fraudulent. Further, if strongly connected component c₁ is the same as the strongly connected component c₂, then the data processing system could determine that the transaction is less likely to be fraudulent for smaller values of n. If strongly connected component c₁ is not the same as strongly connected component c₂, then the data processing system could determine whether transactions are occurring from accounts in strongly connected component c₁ to strongly connected component c₂ or occurring from strongly connected component c₂ to strongly connected component c₁. It should be noted that illustrative embodiments cannot have it both ways because that would be a contradiction of the definition of strongly connected components. Prior transactions are determined to be less suspicious for fraud. This suspicion of fraud is weighted by the sizes of number of accounts n₁ and number of accounts n₂ and random sampling. Another consideration is whether a prior transaction exists between vertex X and vertex Y or between vertex Y and vertex X. If a prior transaction does exist between the two vertices X and Y, then the data processing system could determine that the transaction is less suspicious for fraud. The data processing system utilizes these features as input to the fraud scoring engine for any transaction.

The flowchart for describing the above process is shown in FIG. 10.

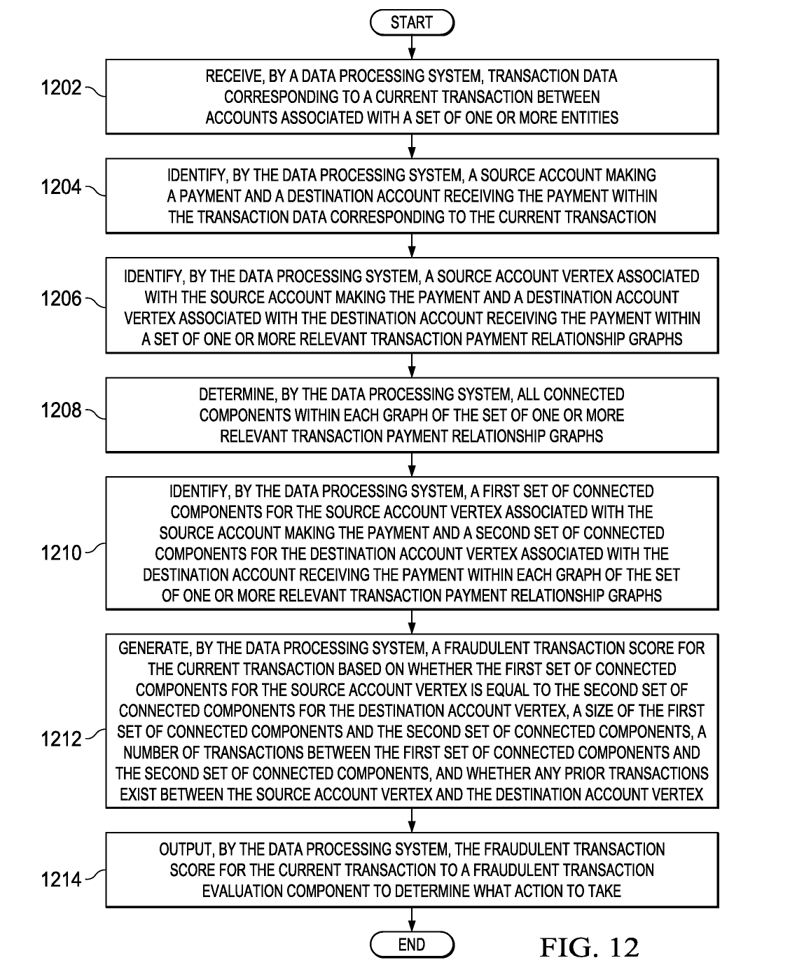

With reference now to FIG. 12, a flowchart illustrating a process for generating a fraudulent transaction score using connected components of a source account vertex and a destination account vertex corresponding to a transaction within a set of one or more relevant transaction payment relationship graphs is shown in accordance with an illustrative embodiment. The process shown in FIG. 12 may be implemented in a data processing system, such as, for example, server 104 or client 110 in FIG. 1 and data processing system 200 in FIG. 2.

The process begins when the data processing system receives transaction data corresponding to a current transaction between accounts associated with a set of one or more entities (step 1202). The data processing system identifies a source account making a payment and a destination account receiving the payment within the transaction data corresponding to the current transaction (step 1204). In addition, the data processing system identifies a source account vertex associated with the source account making the payment and a destination account vertex associated with the destination account receiving the payment within a set of one or more relevant transaction payment relationship graphs (step 1206).

The data processing system determines all connected components, which are either computed ahead of time or in real-time, within each graph of the set of one or more relevant transaction payment relationship graphs (step 1208). Further, the data processing system identifies a first set of connected components for the source account vertex associated with the source account making the payment and a second set of connected components for the destination account vertex associated with the destination account receiving the payment within each graph of the set of one or more relevant transaction payment relationship graphs (step 1210).

Subsequently, the data processing system generates a fraudulent transaction score for the current transaction based on whether the first set of connected components for the source account vertex is equal to the second set of connected components for the destination account vertex, a size of the first set of connected components and the second set of connected components, a number of transactions between the first set of connected components and the second set of connected components, and whether any prior transactions exist between the source account vertex and the destination account vertex (step 1212). Then, the data processing system outputs the fraudulent transaction score for the current transaction to a fraudulent transaction evaluation component to determine what action to take (step 1214).

Two account vertices X and Y are connected if an edge path exists from vertex X to vertex Y, but the two vertices may not be well connected. That is, the removal of a small number of accounts or transactions from the vertices X and Y may diminish the connectivity property between vertices X and Y. One measure of suspiciousness for financial transaction fraud is the number of accounts or transactions that must be removed from the transaction payment relationship graph before the two account vertices X and Y are no longer connected. The greater the number of accounts or transactions, the better connected the two account vertices are, and the less suspicious the transaction is.

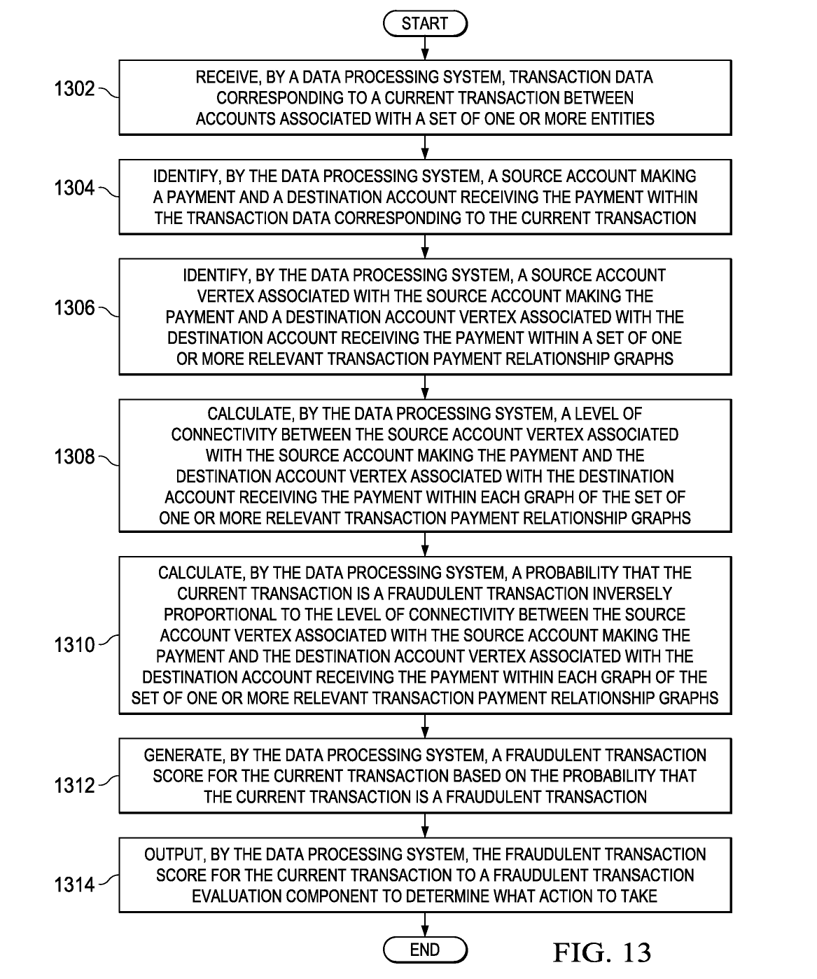

With reference now to FIG. 13, a flowchart illustrating a process for generating a fraudulent transaction score using a level of connectivity between a source account vertex and a destination account vertex corresponding to a transaction within a set of one or more relevant transaction payment relationship graphs is shown in accordance with an illustrative embodiment. The process shown in FIG. 13 may be implemented in a data processing system, such as, for example, server 104 or client 110 in FIG. 1 and data processing system 200 in FIG. 2.

The process begins when the data processing system receives transaction data corresponding to a current transaction between accounts associated with a set of one or more entities (step 1302). The data processing system identifies a source account making a payment and a destination account receiving the payment within the transaction data corresponding to the current transaction (step 1304). The data processing system also identifies a source account vertex associated with the source account making the payment and a destination account vertex associated with the destination account receiving the payment within a set of one or more relevant transaction payment relationship graphs (step 1306).

Then, the data processing system calculates a level of connectivity between the source account vertex associated with the source account making the payment and the destination account vertex associated with the destination account receiving the payment within each graph of the set of one or more relevant transaction payment relationship graphs (step 1308). In addition, the data processing system calculates a probability that the current transaction is a fraudulent transaction inversely proportional to the level of connectivity between the source account vertex associated with the source account making the payment and the destination account vertex associated with the destination account receiving the payment within each graph of the set of one or more relevant transaction payment relationship graphs (step 1310). For example, the greater the level of connectivity between vertices, the less the probability that the current transaction is fraudulent.

Afterward, the data processing system generates a fraudulent transaction score for the current transaction based on the probability that the current transaction is a fraudulent transaction (step 1312). Further, the data processing system outputs the fraudulent transaction score for the current transaction to a fraudulent transaction evaluation component to determine what action to take (step 1314).

Clustering is an unsupervised learning method aimed at finding groups of objects, such that objects within each cluster of objects are similar to each other and objects from different clusters are dissimilar. Clustering is often used as a data exploration tool when no labels are available. In addition, clustering also helps to identify interesting data points, such as outliers. The data processing system utilizes clustering methods to group accounts with “similar” behavior. For example, the data processing system may utilize clustering methods to identify groups of accounts with similar transaction patterns, groups of accounts owned by similar account holders, groups of branches with similar transaction patterns, and groups of merchants with similar customers.

The data processing system may utilize clustering to score current transactions based on whether behavior is consistent with a source account vertex cluster. The data processing system may view strongly connected components as specific examples of account clustering in a transaction payment relationship graph. However, the data processing system may perform clustering based on additional features of the transaction payment relationship graph, such as connectivity, frequency, value, or type of transactions; the number of incoming transactions verses the number of outgoing transactions; types of accounts (e.g., merchants, type of merchants, et cetera); or whether or not two accounts are members of the same bank, whether accounts are in the same country, or whether accounts are in different countries.

The data processing system may apply a clustering algorithm to account transaction features of the transaction payment relationship graph to obtain a set of account vertex clusters. Example clustering algorithms may include k-means, DB-Scan, BIRCH clustering, or Markov clustering. However, it should be noted that the data processing system may utilize any type of clustering algorithm. The data processing system may score transactions for fraud using clusters in a similar manner as scoring transactions using strongly connected components.

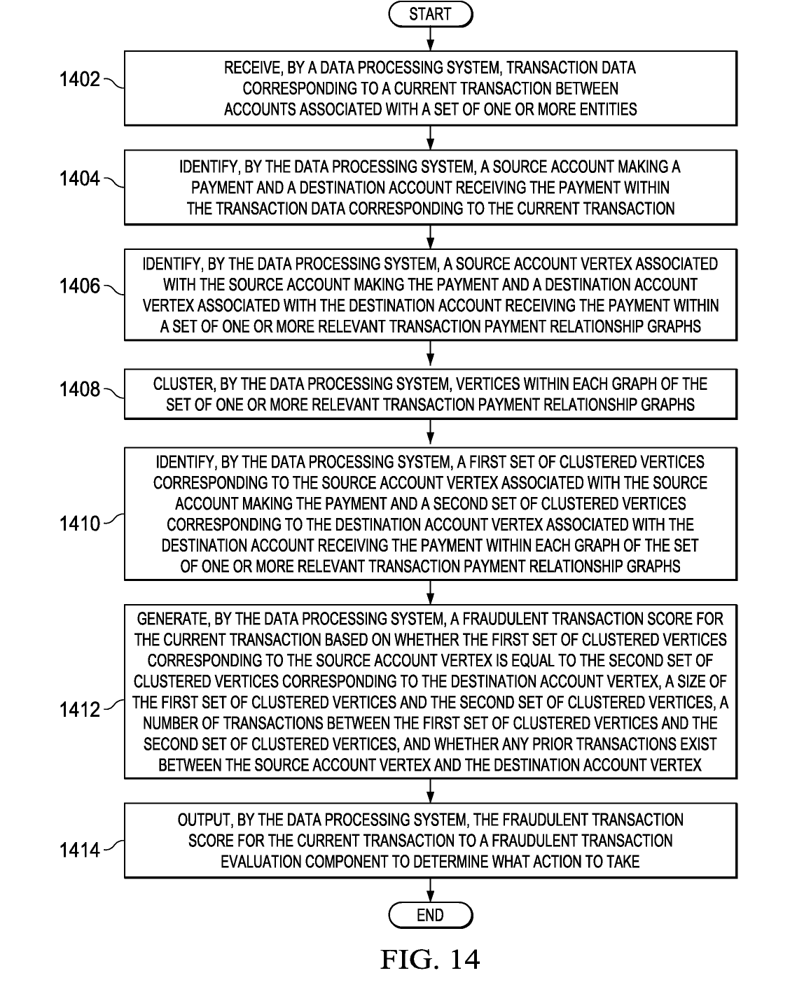

With reference now to FIG. 14, a flowchart illustrating a process for generating a fraudulent transaction score using clustering of vertices within a set of one or more relevant transaction payment relationship graphs is shown in accordance with an illustrative embodiment. The process shown in FIG. 14 may be implemented in a data processing system, such as, for example, server 104 or client 110 in FIG. 1 and data processing system 200 in FIG. 2.

The process begins when the data processing system receives transaction data corresponding to a current transaction between accounts associated with a set of one or more entities (step 1402). The data processing system identifies a source account making a payment and a destination account receiving the payment within the transaction data corresponding to the current transaction (step 1404). The data processing system also identifies a source account vertex associated with the source account making the payment and a destination account vertex associated with the destination account receiving the payment within a set of one or more relevant transaction payment relationship graphs (step 1406).

Further, the data processing system clusters vertices within each graph of the set of one or more relevant transaction payment relationship graphs (step 1408). In addition, the data processing system identifies a first set of clustered vertices corresponding to the source account vertex associated with the source account making the payment and a second set of clustered vertices corresponding to the destination account vertex associated with the destination account receiving the payment within each graph of the set of one or more relevant transaction payment relationship graphs (step 1410).

Subsequently, the data processing system generates a fraudulent transaction score for the current transaction based on whether the first set of clustered vertices corresponding to the source account vertex is equal to the second set of clustered vertices corresponding to the destination account vertex, a size of the first set of clustered vertices and the second set of clustered vertices, a number of transactions between the first set of clustered vertices and the second set of clustered vertices, and whether any prior transactions exist between the source account vertex and the destination account vertex (step 1412). Afterward, the data processing system outputs the fraudulent transaction score for the current transaction to a fraudulent transaction evaluation component to determine what action to take (step 1414).

As an example, c₁ is the cluster corresponding to vertex X; c₂ is the cluster corresponding to vertex Y; and the transaction being scored is from vertex X to vertex Y. If the fraction of transactions originating from an account in cluster c₁ and terminating in an account in cluster c₂, then the transaction is more likely to be fraudulent. If number of accounts in cluster cᵢ is nᵢ, illustrative embodiments use random sampling theory to determine the probability of an account in cluster c₂ being chosen randomly. If the probability of selecting an account in c₂ as the destination accounts given the source is in c₁ is less than the probability of randomly selecting an account in c₂, then the transaction is more suspicious. The data processing system determines that prior transactions are less suspicious for fraud. The data processing system weights this suspicion by the sizes of number of accounts n₁ and number of accounts n₂ and random sampling. If a prior transaction exists between vertex X and vertex Y or between vertex Y and vertex X, then the data processing system determines that the transaction is less suspicious for fraud. The data processing system may also consider the fraction of transactions from cluster c₁ to cluster c₂. The cluster definition yields a transaction transition probability matrix with a probability that a transaction will start from an account in cluster c₁ and end in an account in cluster c₂. Transactions that have a low transition probability, or have been found to be more closely correlated with past fraudulent transactions, are more suspicious for fraud.

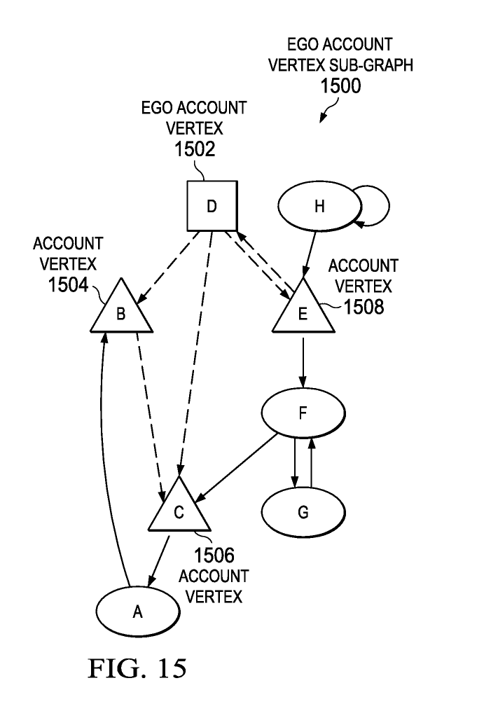

With reference now to FIG. 15, a diagram of an example of an ego account vertex sub-graph is depicted in accordance with an illustrative embodiment. Ego account vertex sub-graph 1500 may be included in a transaction payment relationship graph, such as, for example, transaction payment relationship graph 406 in FIG. 4. In other words, ego account vertex sub-graph 1500 is an egonet or a sub-graph of a transaction payment relationship graph, which is centered on a single vertex (e.g., egonode), such as ego account vertex 1502 D, such that any vertex connected to ego account vertex 1502 within ego account vertex sub-graph 1500 is connected by an edge path of length not greater than k. It should be noted that in most cases k is equal to 1 for scalability and in many transaction payment relationship graphs even smaller values for k may yield the entire transaction payment relationship graph. In this example, vertices connected to ego account vertex 1502 D within ego account vertex sub-graph 1500 by an edge path of length 1 are account vertex 1504 B, account vertex 1506 C, and account vertex 1508 E. In other words, ego account vertex 1502 D, account vertex 1504 B, account vertex 1506 C, and account vertex 1508 E comprise ego account vertex sub-graph 1500. Also, it should be noted that edge paths connecting these vertices comprising ego account vertex sub-graph 1500 are shown as dashed lines for illustration purposes only.

For small values of k, an ego account vertex sub-graph is a good definition of a community of vertices within a transaction payment relationship graph. A clique is a special type of ego account vertex sub-graph where a transaction exists from any source account vertex X in the ego account vertex sub-graph to any destination account vertex Y. To score a transaction, the data processing system determines whether or not destination account vertex Y is in source account vertex X's ego account vertex sub-graph (e.g., whether a prior transaction exists between source account vertex X and destination account vertex Y or from vertex Y to vertex X) or how the inclusion of destination account vertex Y into source account vertex X's ego account vertex sub-graph will affect the features of the ego account vertex sub-graph corresponding to source account vertex X.

For example, if source account vertex X's ego account vertex sub-graph is a clique and adding destination account vertex Y only adds one edge such that no transaction exists from destination account vertex Y to any other vertex member of source account vertex X's ego account vertex sub-graph, then the data processing system determines that the transaction is more than likely fraudulent. The data processing system may calculate an anomaly score based on change in the features of source account vertex X's ego account vertex sub-graph. The feature changes may include, for example, the number of accounts in source account vertex X's ego account vertex sub-graph; the number of edges in source account vertex X's ego account vertex sub-graph; the total monetary incoming and outgoing flow of transactions in source account vertex X's ego account vertex sub-graph; the number of accounts the ego account vertex pays; the number of accounts that pay to ego account vertex; the number of edges incident on the ego account vertex; and the number of edges that don't include the ego account vertex.

Finally, the data processing system considers the difference between an edge path length of k and an edge path length of k+1 within an ego account vertex sub-graph (e.g., size differences between edge path lengths, number of edges between k and k+1 distance account vertices, et cetera). If replacing destination account vertex Y with an account vertex already within source account vertex X's ego account vertex sub-graph is statistically indistinguishable, then the data processing system determines that the transaction is less likely to be fraudulent. The more significant the addition or substitution of a vertex is within an ego account vertex sub-graph, the more the data processing system considers the transaction to be fraudulent.

Thus, illustrative embodiments provide a computer-implemented method, data processing system, and computer program product for utilizing transaction data from one or more transaction channels to score transactions and to utilize the transaction scores to identify and block fraudulent transactions. The descriptions of the various embodiments of the present invention have been presented for purposes of illustration, but are not intended to be exhaustive or limited to the embodiments disclosed. Many modifications and variations will be apparent to those of ordinary skill in the art without departing from the scope and spirit of the described embodiment. The terminology used herein was chosen to best explain the principles of the embodiment, the practical application or technical improvement over technologies found in the marketplace, or to enable others of ordinary skill in the art to understand the embodiments disclosed here.

The flowchart and block diagrams in the Figures illustrate the architecture, functionality, and operation of possible implementations of systems, methods and computer program products according to various embodiments of the present invention. In this regard, each block in the flowchart or block diagrams may represent a module, segment, or portion of code, which comprises one or more executable instructions for implementing the specified logical function(s). It should also be noted that, in some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts, or combinations of special purpose hardware and computer instructions.

What is claimed is:

1. A computer-implemented method for identifying fraudulent transactions, the computer-implemented method comprising:
obtaining, by a data processing system, transactions data corresponding to a plurality of transactions between accounts from one or more different transaction channels;
generating, by the data processing system, at least one graph of transaction payment relationships between the accounts from the transaction data;
extracting, by the data processing system, features from the at least one graph of transaction payment relationships between the accounts; and
generating, by the data processing system, a fraud score for a current transaction based on the extracted features from the at least one graph of transaction payment relationships between the accounts.

2. The computer-implemented method of claim 1 further comprising:
comparing, by the data processing system, the generated fraud score for the current transaction to a fraudulent transaction threshold value to determine a level of suspicion regarding the current transaction.

3. The computer-implemented method of claim 2 further comprising:
responsive to the data processing system determining that the current transaction is fraudulent, blocking, by the data processing system, the current transaction from being completed.

4. The computer-implemented method of claim 1, wherein that data processing system generates the at least one graph of transaction payment relationships between the accounts by adding an edge from a vertex representing a source account of a payment to a vertex representing a destination account for the payment.

5. The computer-implemented method of claim 4, wherein each account of the accounts is represented by an account vertex in the at least one graph of transaction payment relationships between the accounts, and wherein each transaction of the plurality of transactions between accounts is represented by a transaction vertex in the at least one graph of transaction payment relationships between the accounts, and wherein the data processing system adds an edge from a source account vertex to a current transaction vertex and adds an edge from the current transaction vertex to a destination account vertex.

6. The computer-implemented method of claim 5, wherein the data processing system generates the fraud score for the current transaction from the source account to the destination account based on at least one of a plurality of extracted transaction features representing features of the source account vertex and the destination account vertex, changes in the features of the source account vertex and the destination account vertex over time, anomaly scores corresponding to the features of the source account vertex and the destination account vertex, and features regarding the source account vertex and the destination account vertex as a pair of accounts in the at least one graph of transaction payment relationships between the accounts.

7. The computer-implemented method of claim 6, wherein the data processing system generates the features and the anomaly scores using a plurality of transaction payment relationship graphs that were generated based on historic transaction data from various time periods before the current transaction is scored.

8. The computer-implemented method of claim 7, wherein the data processing system utilizes at least one vertex feature for generating the fraud score, and wherein the at least one vertex feature comprises number of transactions, type of transactions, total monetary flow incoming and outgoing in the number of transactions, number of transactions to accounts of given types, type of merchants involved in the number of transactions, and distribution of payments the destination account receives from the source account.

9. The computer-implemented method of claim 7, wherein the data processing system utilizes at least one feature of an egonet of a vertex for generating the fraud score, and wherein the at least one feature of the egonet comprises number of accounts in the egonet, number of transactions in the egonet, number of transactions incident on the vertex as compared to number of transactions incident on other account vertices of the egonet, a weight corresponding to total monetary flow incoming and outgoing in the number of transactions, and a distribution of account types within the egonet, and wherein the account types are at least one of a foreign account, a domestic account, a business account, and a personal account.

10. The computer-implemented method of claim 5, wherein the data processing system utilizes clustering of vertices in the at least one graph of transaction payment relationships between the accounts for transaction fraud scoring.

11. The computer-implemented method of claim 10, wherein the data processing system utilizes a probability of an account in a cluster that the source account vertex belongs to pays an account in a cluster containing the destination account vertex to determine transaction fraud.

12. The computer-implemented method of claim 5, wherein in response to the data processing system determining that the source account vertex and the destination account vertex belong to a same connected component in the at least one graph of transaction payment relationships between the accounts, the data processing system utilizes a degree of connectedness between the source account vertex and the destination account vertex as an indicator of transaction fraud.

13. The computer-implemented method of claim 5, wherein the data processing system utilizes shortest path between the source account vertex and the destination account vertex in the at least one graph of transaction payment relationships between the accounts for transaction fraud scoring, and wherein the shortest path comprises one of a shortest edge path, a shortest reverse edge path, a shortest undirected edge path, a shortest weighted edge path, a shortest weighted reverse edge path, or a shortest weighted undirected edge path.

14. The computer-implemented method of claim 13, wherein the data processing system determines whether the current transaction is fraudulent based on one of the data processing system determining a probability of the current transaction being fraudulent inversely proportional to the shortest path between the source account vertex and the destination account vertex in the at least one graph of transaction payment relationships or the data processing system determining that the current transaction is fraudulent in response to the shortest path being greater than a defined length and determining that the current transaction is not fraudulent in response to the shortest path being less than or equal to the defined length.

15. The computer-implemented method of claim 5, wherein the data processing system utilizes shortest distance between the source account vertex and the destination account vertex in the at least one graph of transaction payment relationships between the accounts for transaction fraud scoring.

16. The computer-implemented method of claim 5, wherein the data processing system utilizes monetary flow between the source account vertex and the destination account vertex in the at least one graph of transaction payment relationships between the accounts for transaction fraud scoring, and wherein the data processing system determines that the current transaction is fraudulent based on one of the data processing system determining a probability of the current transaction being fraudulent inversely proportional to a maximum monetary flow between the source account vertex and the destination account vertex corresponding to the current transaction or the data processing system determining that the monetary flow between the source account vertex and the destination account vertex in the at least one graph of transaction payment relationships is less than a monetary flow threshold value.

17. The computer-implemented method of claim 5, wherein the data processing system utilizes at least one of a PageRank and a reverse PageRank of the source account vertex and at least one of a PageRank and a reverse PageRank of the destination account vertex in the at least one graph of transaction payment relationships between the accounts for transaction fraud scoring, and wherein the data processing system determines that the current transaction is fraudulent based on one of the data processing system determining a probability of the current transaction being fraudulent inversely proportional to the reverse PageRank of the source account vertex and the PageRank of the destination account vertex corresponding to the current transaction or the data processing system determining that the reverse PageRank of the source account vertex is less than a reverse PageRank threshold value and the PageRank of the destination account vertex is less than a PageRank threshold value.

18. A data processing system for identifying fraudulent transactions, the data processing system comprising:
a bus system;
a storage device connected to the bus system, wherein the storage device stores program instructions; and
a processor connected to the bus system, wherein the processor executes the program instructions to:
obtain transactions data corresponding to a plurality of transactions between accounts from one or more different transaction channels;
generate at least one graph of transaction payment relationships between the accounts from the transaction data;
extract features from the at least one graph of transaction payment relationships between the accounts; and
generate a fraud score for a current transaction based on the extracted features from the at least one graph of transaction payment relationships between the accounts.

19. A computer program product for identifying fraudulent transactions, the computer program product comprising a computer readable storage medium having program instructions embodied therewith, the program instructions executable by a data processing system to cause the data processing system to perform a method comprising:
obtaining, by the data processing system, transactions data corresponding to a plurality of transactions between accounts from one or more different transaction channels;
generating, by the data processing system, at least one graph of transaction payment relationships between the accounts from the transaction data;
extracting, by the data processing system, features from the at least one graph of transaction payment relationships between the accounts; and
generating, by the data processing system, a fraud score for a current transaction based on the extracted features from the at least one graph of transaction payment relationships between the accounts.

20. The computer program product of claim 18 further comprising:
comparing, by the data processing system, the generated fraud score for the current transaction to a fraudulent transaction threshold value to determine a level of suspicion regarding the current transaction.
